(19) United States
(12) Patent Application Publication
(10) Pub. No.: US 2026/0366708 A1
(43) Pub. Date: Nov. 19, 2026

(54) HELMET LIGHT SYSTEM FOR FASTENING TO A PROTECTIVE HELMET AND PROTECTIVE HELMET WITH A HELMET LIGHT SYSTEM

(71) Applicant: Pfanner Schutzbekleidung GmbH, Koblach (AT)

(72) Inventor: Anton PFANNER, Hohenems (AT)

(73) Assignee: Pfanner Schutzbekleidung GmbH, Koblach (AT)

(21) Appl. No.: 19/142,947

(22) PCT Filed: Dec. 15, 2023
(86) PCT No.: PCT/EP2023/086151

§ 371 Date: Jun. 24, 2025

(30) Foreign Application Priority Data
Dec. 28, 2022 (DE) 10 2022 134 890.3

(51) Int. Cl. F21V 21/084; A42B 3/04; F21L 4/08

(52) U.S. Cl. CPC F21V 21/084; A42B 3/0446; F21L 4/08

(57) ABSTRACT

A helmet light system fastens to a protective helmet, wherein the helmet light system includes a helmet light which has a connector plug; a battery holder with a battery pack which has an electrical connection; a connection cable with a plug and a connector plug, wherein the plug can be connected to the plug connection and the connector plug can be connected to the electrical connection, wherein the connector plug has magnets which interact with the battery pack and which exert a force on the connector plug which pulls the connector plug into its connection position in which respective connection surfaces of the connector plug and of the battery pack come to rest on one another, or keeps it there.. A protective helmet includes such a helmet light system.

The present invention relates to a helmet light system for fastening to a protective helmet and to a protective helmet with such a helmet light system.

Many jobs, especially in the forestry sector, require wearing a protective helmet. A corresponding protective helmet, which comprises a helmet shell with an interior fitting with an assembly which touches the head, at least one support cage, a head band and a neck band, and means for fastening this assembly to the helmet shell, is known, for example, from DE 87 14 490 U1.

This known protective helmet represents a basic helmet which can be adapted to the various tasks under different employment conditions by changing add-on elements. The protective helmet consists of a helmet shell and a minimum interior fitting. The interior fitting consists of a cruciate band, with which the helmet is worn on the head and which guarantees an impact-resistant distance between the head and the helmet shell. On its outer circumference, the protective helmet has a projection which surrounds the lateral and the rear part of the helmet and which contains, at the lower rim, four recesses for fastening the cruciate band and further recesses for fastening additional add-on elements. The basic version of the helmet can be used as a simple universal helmet without any extras. The extras can be added or removed as required.

The helmet accessories which are to be fastened to the protective helmet in a meaningful manner also include a helmet light system which additionally illuminates, in particular in a manner similar to a headlamp, with its associated energy source, for example the operating range of a user of the protective helmet or other areas. Such additional illumination of the operating range or other areas can be expedient not only during dawn and dusk and after nightfall, but also in areas shielded from daylight, for example the twilight under a closed tree crown. Further, a helmet light which can be fastened to the protective helmet can also be advantageous in the most varied of activities. For example, nightly repairs to construction machinery on construction sites or maintenance work in dark, poorly lit supply tunnels or under bridges can be executed in a better and more efficient way if a suitable lighting means in the form of a helmet light is carried “on the man” ready to be employed

Such helmet light systems usually generate light from electrical energy, wherein the electrical energy required for this is normally stored and carried along in a chemical form, for example as a battery pack or a rechargeable battery pack which is part of the helmet light system. This creates the need that the connection between the battery pack and the light-emitting part of the helmet light system offers an “attack surface” on the protective helmet which is as small as possible in order to guarantee the safety of the user of the protective helmet. An attack surface is, in particular, cable loops which are freely accessible from outside, which can in particular get caught on branches and in doing so, possibly tear the protective helmet of a user wearing the protective helmet from their head during a reckless move.

The present invention is therefore based on the object of providing a helmet light system and a helmet light with a helmet light system which each increase the safety of a wearer of the helmet.

This object is achieved with the help of the subject matters with the features of the independent claims. Useful designs and further developments result from the dependent claims.

The helmet light system according to the invention provides that the helmet light system comprises a helmet light which has a plug connection, a battery holder with a battery pack which has an electrical connection, a connection cable with a plug and a connector plug, wherein the plug can be connected to the plug connection and the connector plug can be connected to the electrical connection, wherein the connector plug has magnets which interact with the battery pack and which exert a force on the connector plug which pulls the connector plug into its connection position in which respective connection surfaces of the connector plug and the battery pack come to rest on one another, or keeps it there. This coupling mechanism enables caught up cable loops to open when the user of a protective helmet equipped with the helmet light system makes a careless move. As soon as the pull on the caught up cable loop exceeds the holding force which can be applied by the magnets, the connector plug is automatically released from the battery pack, while the cable loop opens. Further, connecting the connector plug to the battery pack becomes easier since the magnets automatically pull the two components of the plug connection into the right position so that the blind closing of the connection is greatly simplified.

Usefully, it can be provided that the connector plug has a projection and the battery pack has a recess corresponding to the projection, wherein the projection lies in the recess when the connector plug is correctly connected to the battery pack. With the help of the combination of the projection and the recess, a simple joining aid for the plug connection can be realized, which does not interfere with the simple release in case of a tensile force on the connector plug and at the same time ensures that, in case of absence of a tensile force, the electrical contacts closed with the help of the plug connection remain connected to one another in a safe and especially correct manner.

In this context, it can be provided that the projection and the recess are each formed to be asymmetrical, preferably on the rim, of the respective connection surfaces. This, a simple anti-rotation protection is realized.

It can also be provided that an electrical contact surface is formed on the connection surface of the battery pack and an electrical contact is formed on the connection surface of the connector plug. The electrical connections are thus established between flat contact surfaces isolated from one another as connection surfaces on the battery pack and associated electrical contact pins on the connector plug. Alternatively, the arrangement of flat contact surfaces and associated contact pins on the battery pack and the connector plug can also be reversed. The interaction between the flat surface and the contact pin lying thereon also allows a lateral removal of the connector plug from the battery pack without damages, for example bending or tearing of contacts, have to be feared.

It can further be provided that one of the connection surfaces has a collar surrounding this connection surface with a sealing lip directed to the connection surface. This collar, together with the sealing lip, seals the electrical connection.

Usefully, it can be provided that the battery pack has magnets which interact with the magnets of the connector plug and, in doing so, exert a force which pulls the connector plug into its connection position or keeps it there. By providing further magnets on the battery pack, the connection between the battery pack and the connector plug becomes more reliable. Further, a simple anti-rotation protection can also be realized through the arrangement of the magnets.

Advantageously, it can be provided that the helmet light system further comprises a charging plug, wherein the connector plug, on its back side opposite the connection surface, has a further connection surface with an electrical contact surface for connecting the charging plug. This enables the simultaneous connection of the connector plug and the charging plug on the battery pack so that, for example, several batteries can also be connected to the helmet light of the helmet light system at the same time in this manner. Further, charging the battery pack during the use of the helmet light is also possible.

In one embodiment, it can be provided that the charging plug has a projection and the connector plug has a corresponding recess on the further connection surface, wherein the projection is in the recess when the charging plug is correctly connected to the connector plug. With the help of the combination of the projection and the recess, a simple joining aid for the plug connection between the charging plug and the connector plug can be realized, which does not interfere with the simple release in case of a tensile force on the charging plug and at the same time ensures that, in case of absence of a tensile force, the closed electrical contacts remain connected to one another in a safe and especially correct manner.

It can further be provided that the charging plug can be directly connected to the battery pack for charging the battery pack. Through this embodiment, the components of the helmet light system can be coupled with one another in a more flexible way.

Further, a protective helmet with such a helmet light system is described.

Exemplary designs of the invention or of some components and constituents of the invention are described in more detail below with reference to the drawings.

In the drawings:

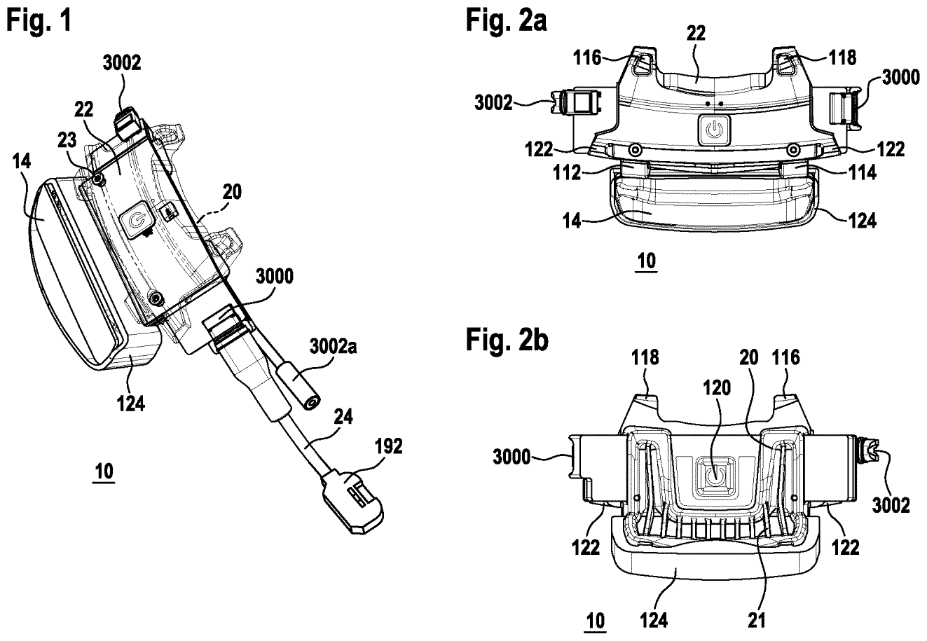

FIG. 1 shows a three-dimensional view of a helmet light;

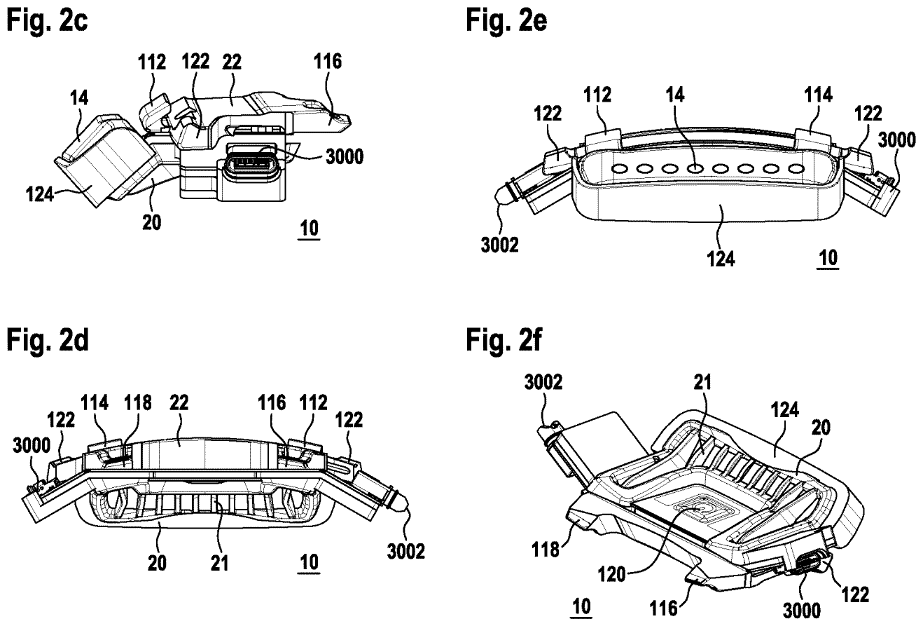

FIGS. 2a to 2f show further three-dimensional views of a helmet light from different viewing directions;

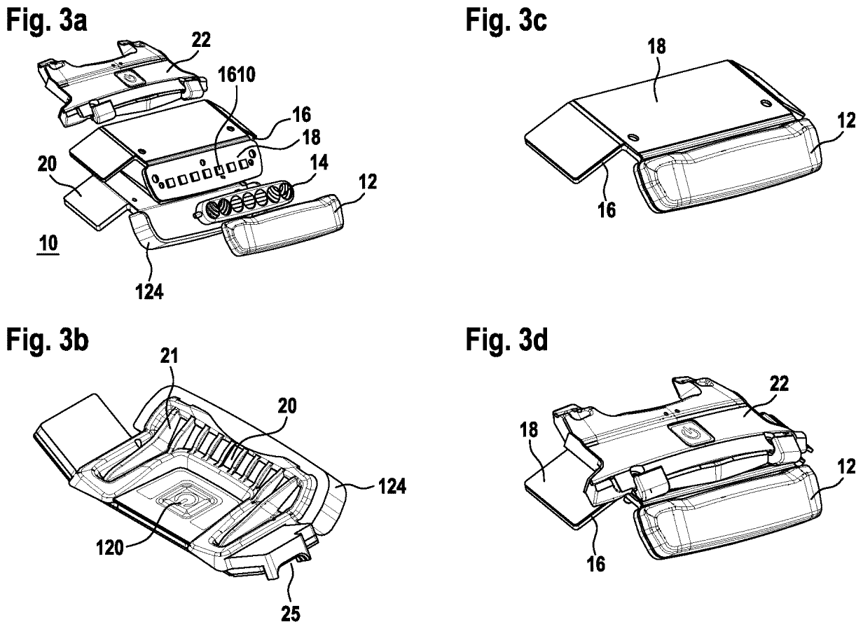

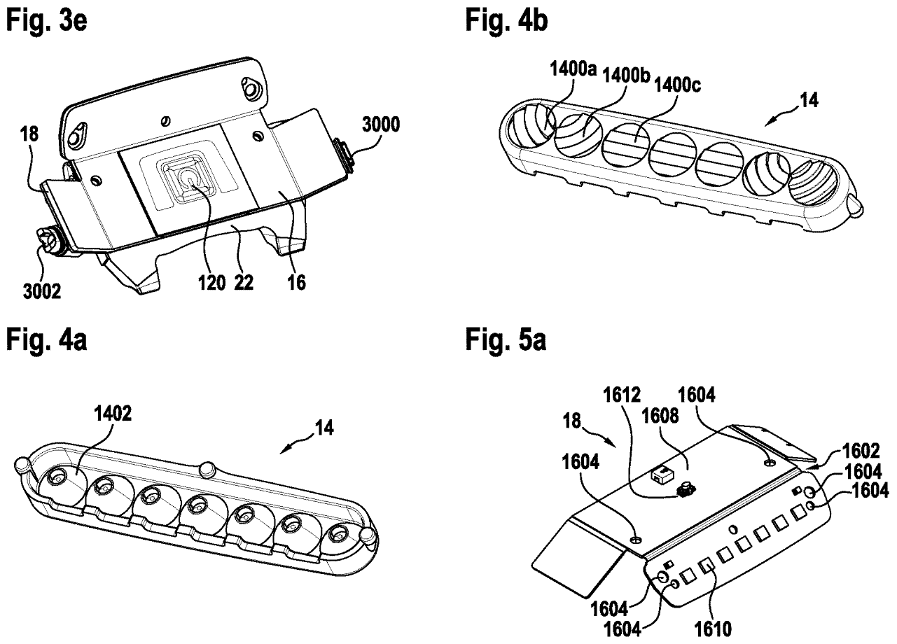

FIG. 3a shows a three-dimensional isometric view of a helmet light in an exploded representation;

FIGS. 3b to 3e show a helmet light partially from different viewing directions;

FIGS. 4a and 4b show a lens unit of the helmet light from behind and from the front;

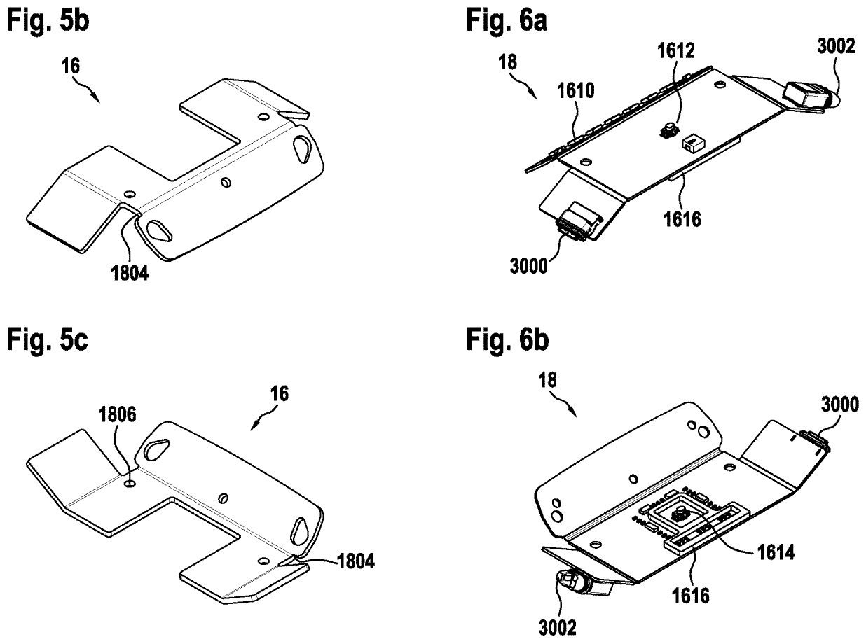

FIG. 5a shows a controller board of the helmet light;

FIGS. 5b and 5c show a carrier element of the helmet light from above and from behind;

FIGS. 6a and 6b show a controller board of a helmet light from further viewing directions;

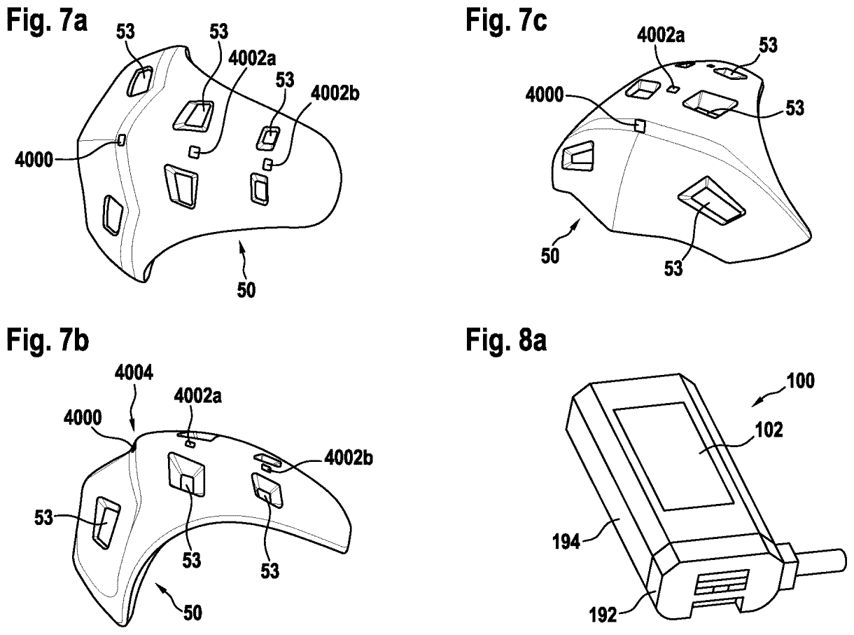

FIGS. 7a to 7c show a ventilation slide of a protective helmet from different viewing directions;

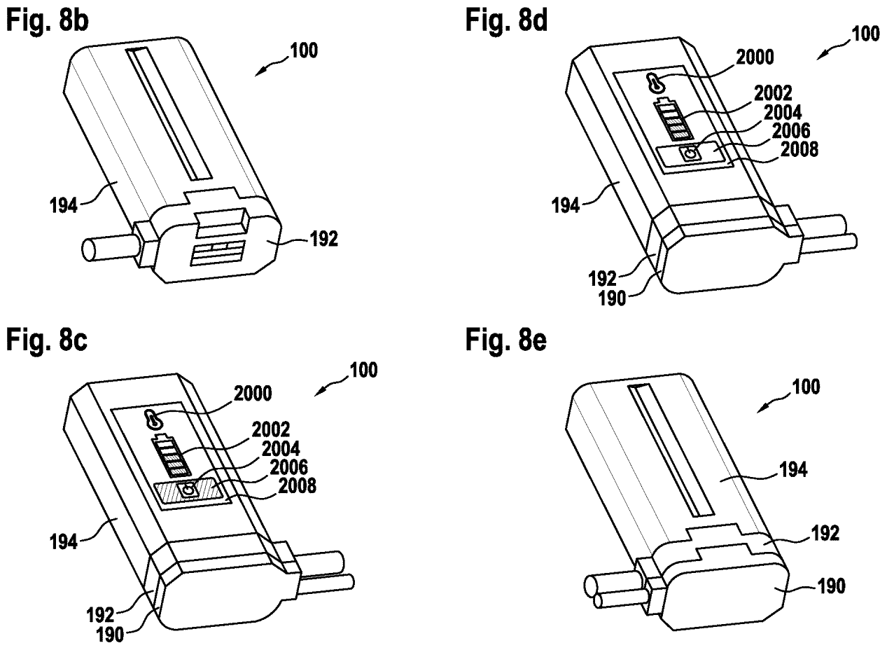

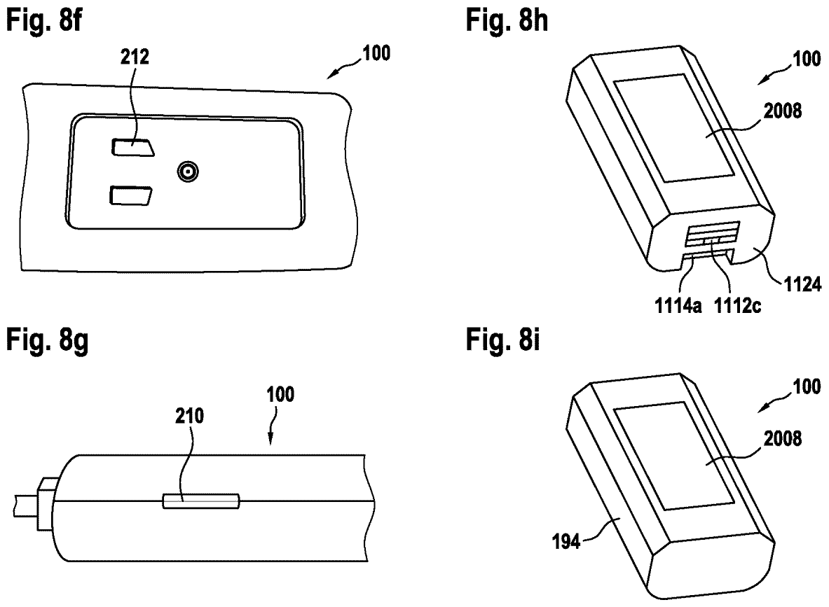

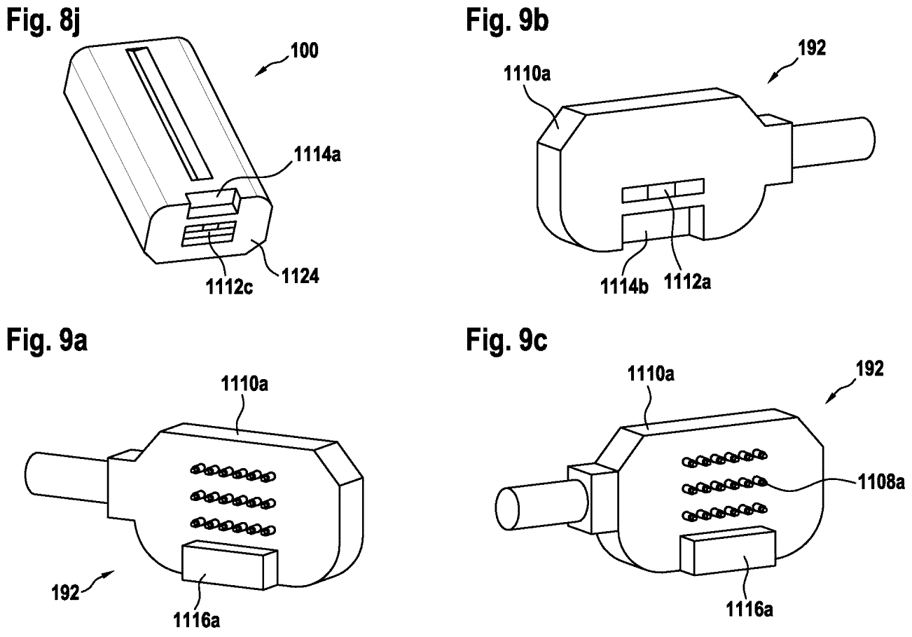

FIGS. 8a to 8j show three-dimensional external views of a battery pack from different viewing directions and in different operating states;

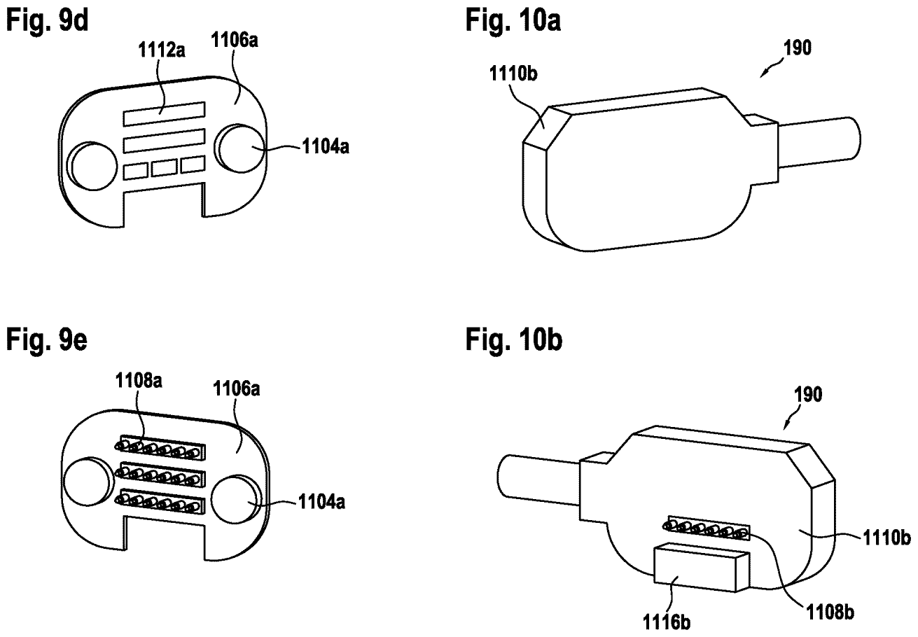

FIGS. 9a to 9c show three-dimensional representations of a connector plug from different viewing directions;

FIGS. 9d and 9e show an internal setup of a connector plug from different viewing directions;

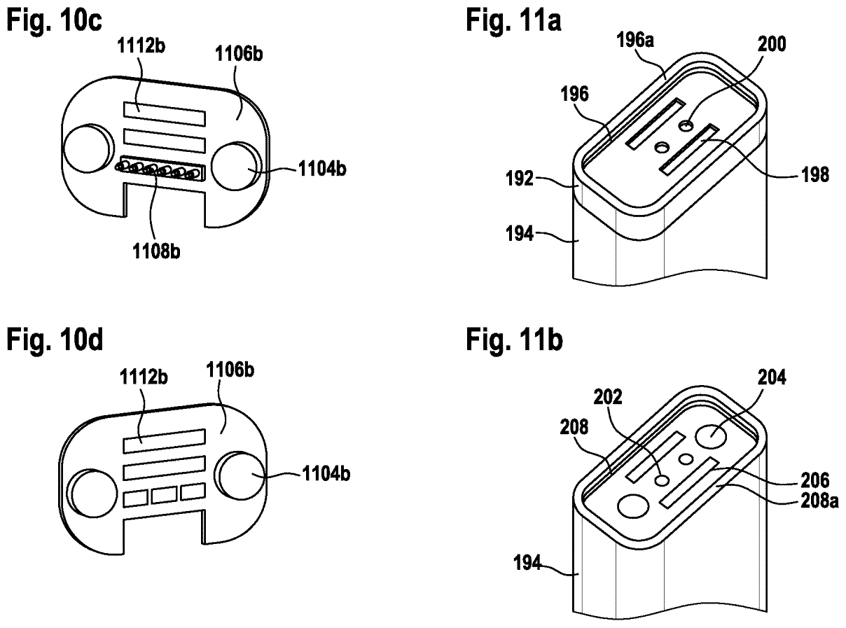

FIGS. 10a and 10b show a three-dimensional external view of a charging plug from different viewing directions;

FIGS. 10c and 10d show an internal setup of a charging plug from different viewing directions;

FIGS. 11a and 11b show three-dimensional representations of a charging connection of a battery pack;

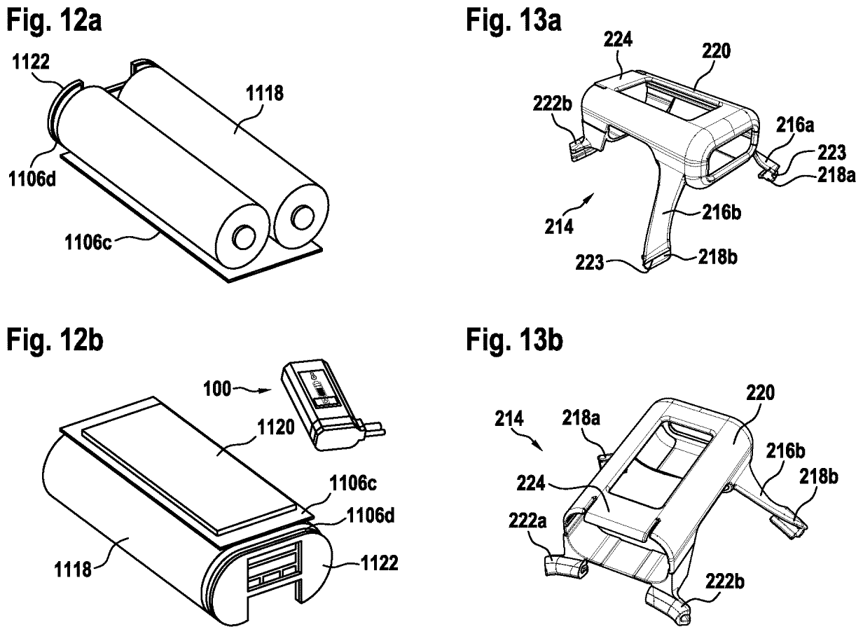

FIGS. 12a and 12b show an internal setup of a battery pack from different viewing directions;

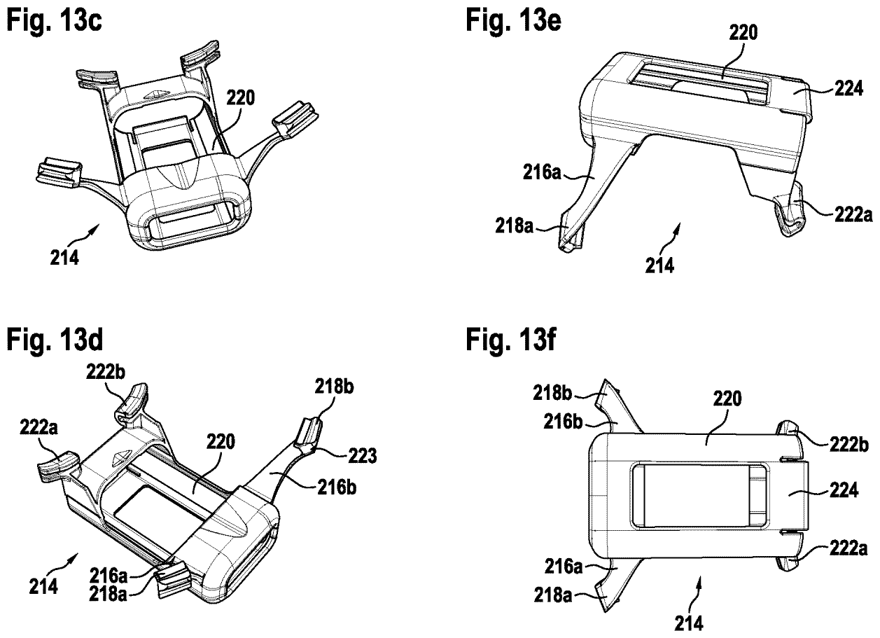

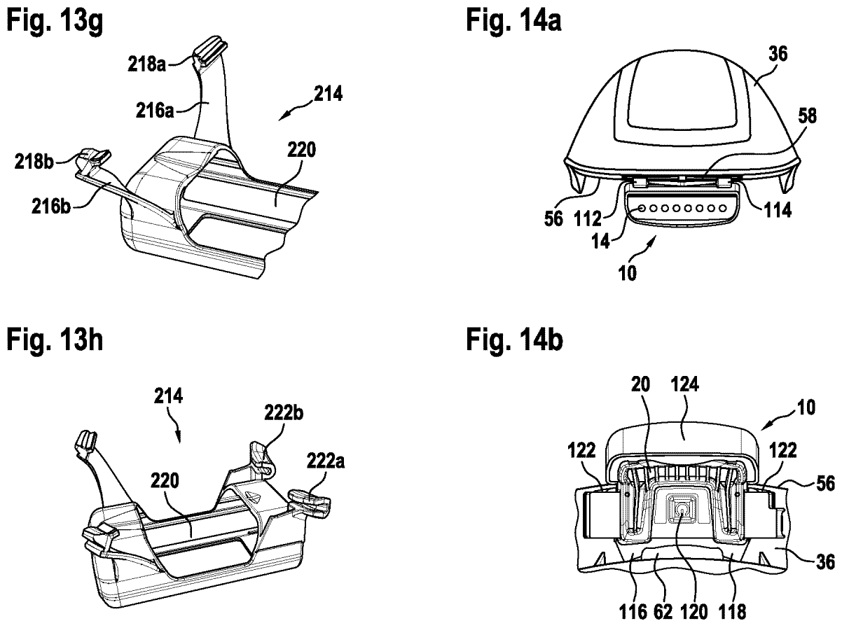

FIGS. 13a to 13h show three-dimensional representations of a battery holder from different viewing directions;

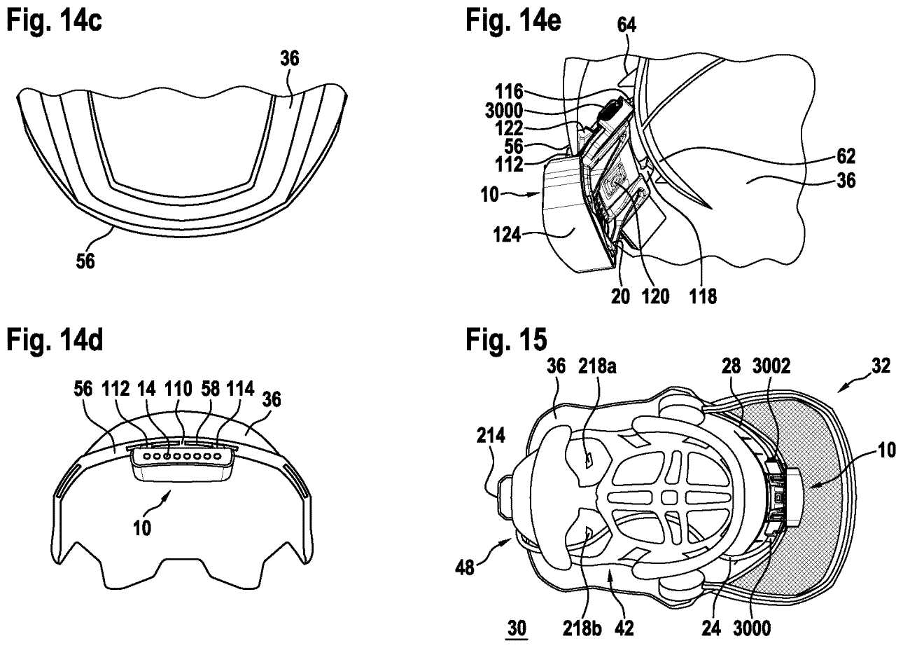

FIGS. 14a to 14e show a helmet shell with a helmet light from different viewing directions;

FIG. 15 shows a three-dimensional view of a helmet shell with a helmet light fastened thereto from below;

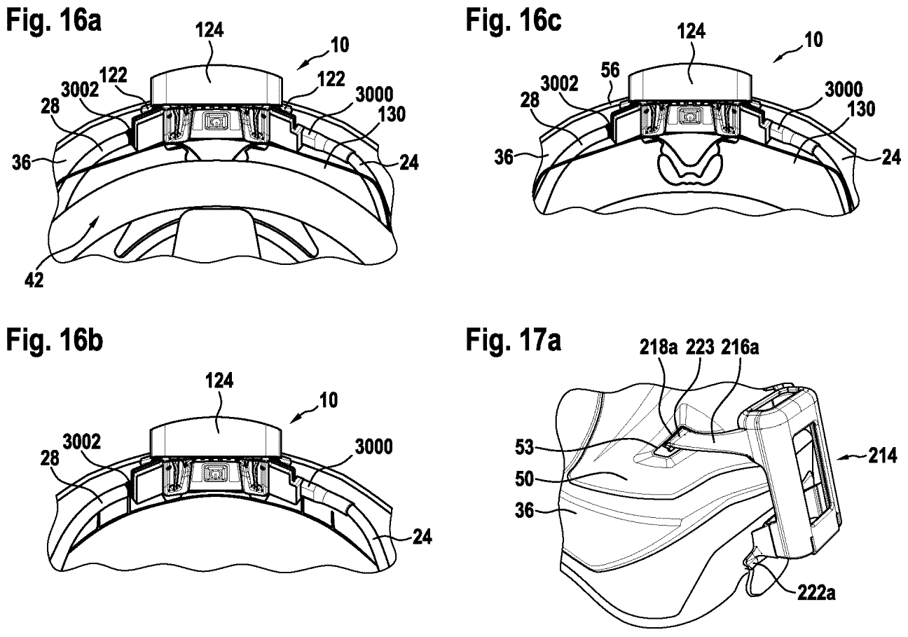

FIGS. 16a to 16c show detailed views of a helmet shell with a helmet light fastened thereto from below;

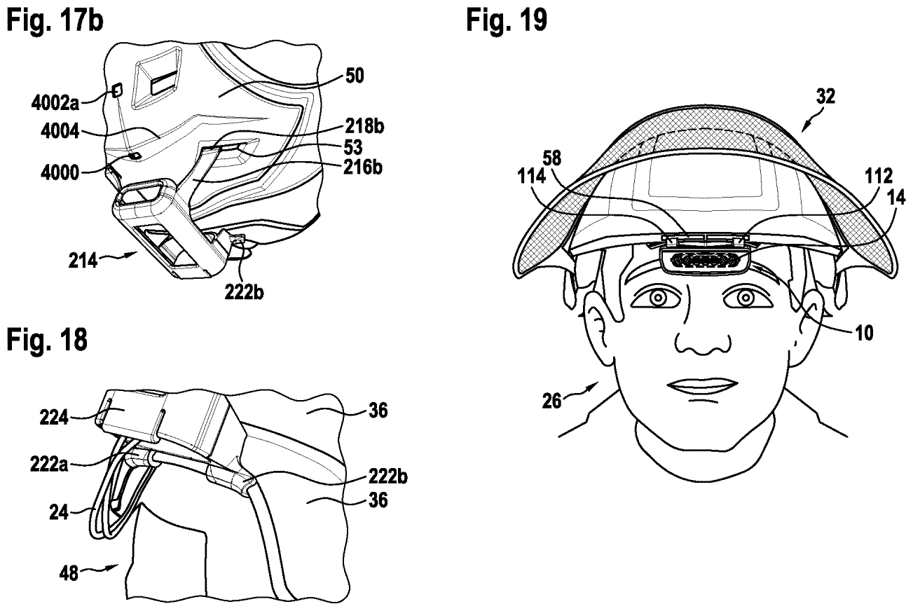

FIGS. 17a and 17b show detailed views of a helmet shell with a battery holder fastened thereto from different viewing directions;

FIG. 18 shows a detailed view of a helmet shell with a battery holder fastened thereto and an inserted battery pack;

FIGS. 19 to 21 show frontal views of a protective helmet with a helmet light fastened thereto from the front;

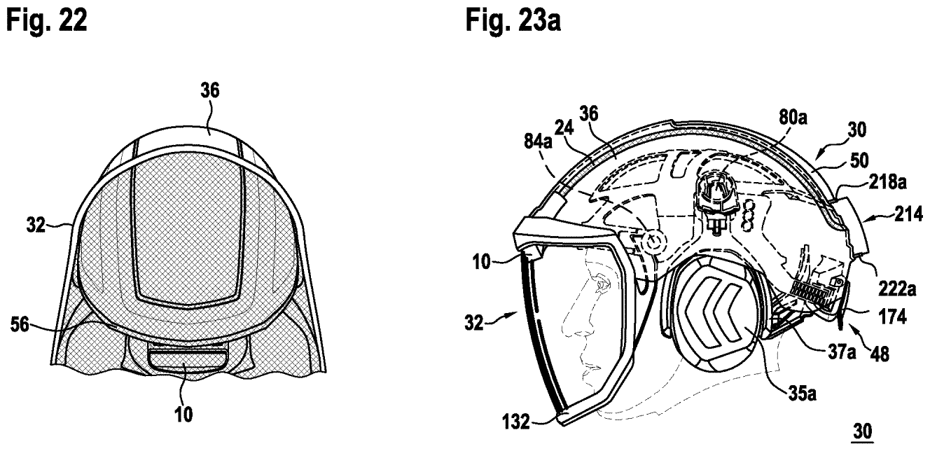

FIG. 22 shows a detailed view of a protective helmet with a helmet light fastened thereto from obliquely above;

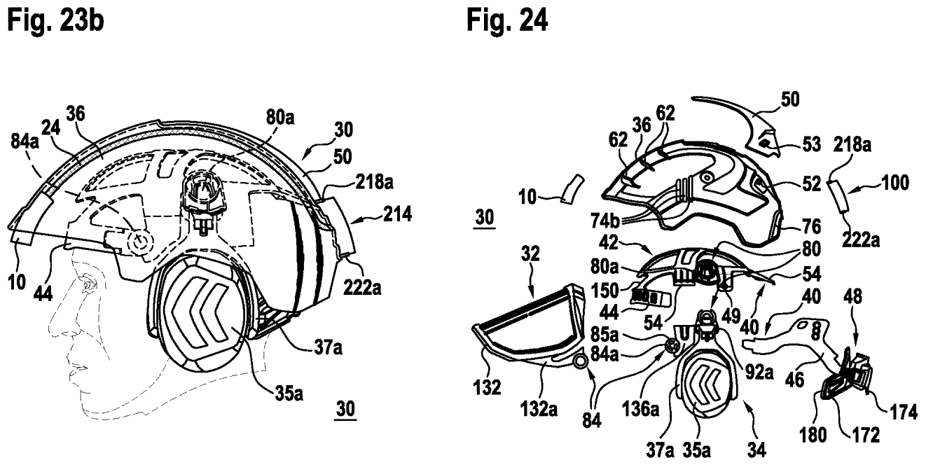

FIG. 23a shows a lateral sectional view through a protective helmet with a helmet light fastened thereto;

FIG. 23b shows a further lateral sectional view of a protective helmet with a helmet light fastened thereto;

FIG. 24 shows a lateral exploded representation of a protective helmet with different accessories; and

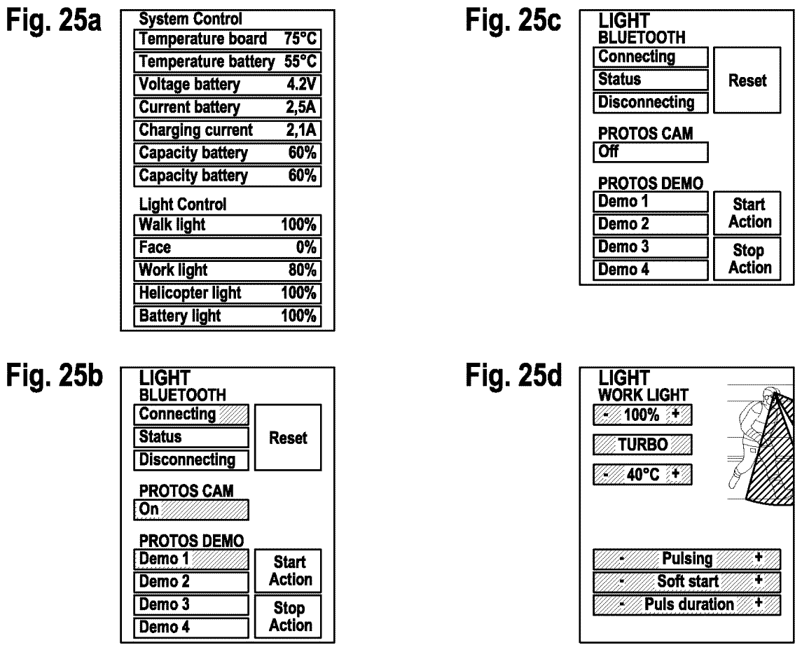

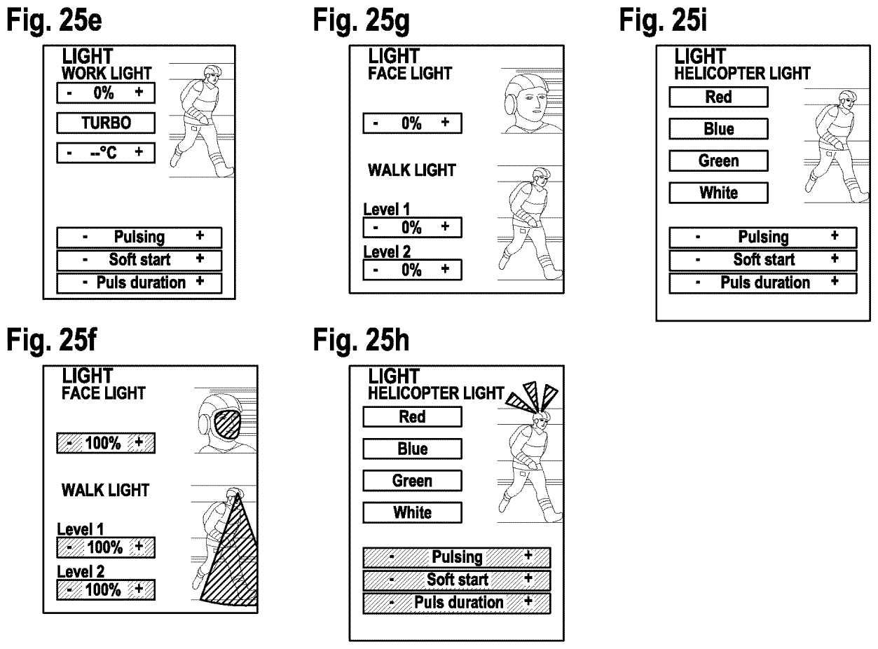

FIGS. 25a to 25i show parts of a graphical user interface for operating a helmet light.

In the following description of the drawings, identical reference numerals denote identical or comparable components.

FIGS. 1 and 2a to 2f show three-dimensional views of a helmet light from different directions. A helmet light 10 represented in each case comprises a lens unit 14 with a glare shield 124 arranged thereon, as well as a main body, of which at least parts of a cooler element 20 and of a cover element 22 can be seen in the figures in each case. The cooler element 20 and the cover element 22 can, for example, be arranged on opposite sides of the main body of the helmet light 10, as can be seen in FIG. 1, and can be fastened to one another, for example, by screws 23, which in each case pass through the main body. An additional or exclusive gluing, instead of the screw fastening, of the cooler element 20 and/or of the cover element 22 is also possible. Further alternative fastening possibilities are also conceivable, for example the use of a destructively removable fastening element for the cooler element 20 and/or the cover element 22, by means of which, for example, a simple reparability of the helmet light 10 is maintained, but a manipulation of the electronics of the helmet light 10 based on the then damaged fastening element can be reproduced. The cover element 22 can consist of one or more parts which are connected to one another in a fixed or loose manner. In the example represented, the cover element 22 consists of a single part.

In the three-dimensional view represented in FIG. 1, the cooler element 20 is located on the side of the helmet light 10 facing away from the observer and is largely covered by the cover element 22, for which reason, in order to illustrate the connection between the cooler element 20 and the cover element 22 and further to give the observer an idea of the shape of the main body of the helmet light 10, hidden areas of the cooler element 20 are represented in broken lines in FIG. 1. The helmet light 10 has a plug connection 3000 and a connecting plug connection 3002 at mutually opposite lateral end areas. The plug connection 3000 can be, for example, a USB connection, in particular a USB type C connection. Instead of the arrangement of the two aforementioned plug connections represented in the figures, a common arrangement on a single side of the helmet light 10 is also conceivable. However, the arrangement on opposite sides of the helmet light 10 has certain advantages with regard to cable routing, since an available space for mounting the helmet light 10 is limited, as will be explained below. In FIG. 1, in addition to the plug connection 3000, a connecting connection 3002a is also represented, which can be provided additionally or alternatively, as required, in particular to the connecting plug connection 3002. The connecting connection 3002a in FIG. 1 is located, for example, on the same side of the helmet light 10 on which the plug connection 3000 is also provided. The connecting connection 3002a is coupled directly to the main body of the helmet light 10 and is, for example, firmly soldered to a controller board 18 associated with the main body of the helmet light 10. The connecting plug connection 3002 and/or the connecting connection 3002a can be used, for example, for connecting accessory parts to the helmet light 10. Accessory parts for the helmet light 10 can be, for example, further lighting elements freely positionable or fixed to a helmet shell 36, for example lighting elements which form a “helicopter LED”, which will be described in more detail below. Additional lighting elements which can be attached to the rim of the helmet shell in order to realize a face illumination are also conceivable. Such a face illumination can be advantageous in particular in case of salvage/rescue of persons, since the protective helmet generally leaves the face of the user/wearer in the shade, so that an already frightened person could possibly panic if they cannot recognize the user of the protective helmet approaching them or cannot recognize them as a normal person, and unintentionally impedes the rescue/salvage.

The plug connection 3000 and the connecting plug connection 3002 can each, just like the connecting connection 3002a, be mounted on a printed circuit board carrying further electrical components of the helmet light 10, which will be described in more detail below by way of example in the form of the controller board 18.

In the figures, the lens unit 14 is regularly surrounded by the glare shield 124, which prevents or at least reduces an undesired exit of scattered light from the lens unit 14. In this way, for example, the wearing of the helmet light 10 in the activated state can be made more pleasant for a user, since light emerging from the lens unit 14 does not pass directly into the eyes of the user. The glare shield 124 can consist, for example, of rubber, plastic, GRP, a metal sheet, or a similarly mechanically insensitive material which is impenetrable to visible light. The glare shield 124 can be removably fixed to the lens unit 14, for example, by means of a clamping action. In this way, for example, a replacement of the glare shield 124 can be realized in the event of damage. In this way, the adaptation of the glare shield 124 used can also be made possible by means of a glare shield 124 adapted to the respective intended employment purpose. It is conceivable, for example, that the glare shield 124 is provided in the radiation direction of the lens unit 14 in a manner not represented with an additional partially transparent element in order to modify a radiation characteristic/light intensity of the helmet light 10. Alternatively, the glare shield 124 can also be firmly and permanently connected to the helmet light 10, for example by an adhesive bond or a destructively releasable latching.

As already indicated, the helmet light 10 can further comprise a face illumination unit not represented separately in FIG. 1. With the help of this face illumination unit, illumination of a face area can be achieved by specially oriented lighting elements which can be arranged separately from a “helmet light body” containing the helmet light 10 in a face illumination unit. This facial illumination unit can then be fixedly positioned, similarly to the actual helmet light 10, on an inner rim of a protective helmet. It is also possible for the face illumination unit to be integrated directly into the helmet light 10. For example, the special lighting elements can be arranged on the rear side of the lens unit 14 in such a way that they emit diffuse light past the glare shield 124 onto the face of the user.

In FIG. 1, a connection cable 24 at the plug connection 3000 is also recognizable, which ends at the end of the connection cable 24 opposite the plug connection 3000 in a connector plug 192, which will also be described in more detail below.

The helmet light 10 can be switched over between several different operating modes, wherein each one of these operating modes is characterized in that light is emitted by the helmet light, unless it is explicitly indicated that one of the operating modes is to be the switched-off state of the helmet light. The several different operating modes can be characterized, for example, in that different areas in the vicinity of the helmet light 10 are illuminated without the helmet light 10 being moved in its position or orientation. Examples which may be mentioned at this point are a face illumination, a short-range illumination, an operating range illumination, a long-range illumination, a helicopter light, and a position light. These individual different lighting modes of the helmet light 10 can additionally also be used/controlled in any desired combinations with one another, which further increases the number of operating modes which differ from one another.

The helmet light 10 can also assume different operating states in each of the several different operating modes or can be operated in these. For example, an illuminance, that is to say a brightness of the emitted light, can be changed. This change can in particular also be designed to be variable in time. In addition, a luminous color of the respectively controlled light-emitting elements of the helmet light 10 can also be variable and adaptable.

In FIG. 2a, the helmet light 10 is represented three-dimensionally from above, so that, in addition to the lens unit 14 with the glare shield 124, the connecting plug connection 3002 on the left side and the plug connection 3000 on the right side, details of the cover element 22 can be recognized in particular. The cover element 22 has various elements which in particular serve to releasably fix the helmet light 10 to the helmet shell 36 described in more detail below. For mounting the helmet light 10, the cover element 22 comprises at least four fastening points. FIG. 2a represents on the left side in each case a rear holding claw 116, a front holding claw 112 and a holding element 122. In a manner symmetrical to this, the cover element 22 likewise comprises a rear holding claw 118, a front holding claw 114 and a holding element 122 on the side represented on the right in FIG. 2a. In total, the cover element 22 in the example thus comprises six fastening points, wherein more or fewer fastening points can also be provided as long as at least four fastening points are provided. The mode of operation of the front holding claws 112, 114, the holding elements 122 and the rear holding claws 116, 118 will be described in more detail below. The cover element 22 can be made of similar materials as the glare shield 124, wherein the cover element 22 is preferably made of an electrically insulating material, which is, however, not absolutely necessary. In FIG. 2a, a central on/off switch, not described in more detail, can be recognized, with the help of which, for example, it is possible to switch the helmet light 10 on/off. Since this on/off switch is hardly accessible when the helmet light 10 is mounted on the helmet shell 36, this on/off switch can be considered as optional, for example, in order to address basic functions of the helmet light 10 when the helmet light 10 is held by a user in the hand and is not mounted on the helmet shell 36.

When the helmet light 10 is in the mounted state, the cooler element 20, which is readily recognizable in particular in FIG. 2b, faces away from the helmet shell 36 and points in the direction of the helmet interior. The cooler element 20 is provided with cooling ribs 21 which improve the dissipation of heat and which can dissipate heat which is produced during operation of the helmet light 10 in order to prevent overheating of the helmet light 10. A switch 120 is provided in the center of the cooler element 20, which can be used in a simple manner for switching the helmet light 10 on/off even in the mounted state of the helmet light 10. By actuating the switch 120, the helmet light 10 can be switched in particular from a completely switched off state into a type of standby mode in which the helmet light 10 does not emit light but can be further controlled only with the help of external operating elements. This can be regarded as a standby state in which as little energy as possible is consumed, but at the same time a flexible control of the helmet light 10 is possible at any time. It is conceivable that upon actuation of the switch 120, for example, an optical and/or acoustic signaling can take place, which signals to the user the readiness for use or the switching off of the helmet light 10.

As already mentioned, the cooler element 20 and the cover element 22 form substantial parts of the outer surfaces of the main body of the helmet light 10. The cover element 22 and the cooler element 20 thereby also assume a mechanical stiffening and protective function, wherein the cooling ribs 21 arranged on the cooler element 20 and a circumferential bead at the rim of the cooler element 20 contribute to the further stiffening.

On the lens unit 14, in particular in FIG. 2e, several individual round lenses are indicated which are separated from one another and which substantially serve for the directed light radiation of the helmet light 10. The inner structure of the lens unit 14 with the lenses indicated here will be explained in the following in FIGS. 4a and 4b.

The curved shape of the helmet light 10 can further be clearly recognized in FIGS. 2e and 2f. The mutually opposite areas of the main body of the helmet light 10, on which the plug connection 3000 or the connecting plug connection 3002 are arranged, are inclined with respect to the central area of the main body of the helmet light 10, in order to adapt in its intended mounting position on a helmet shell 36 to a curvature predetermined thereby.

FIG. 3a shows a three-dimensional isometric view of a helmet light 10 in an exploded representation. The helmet light 10 which can be recognized in FIG. 3a is represented in simplified form. A controller board 18 can be recognized between the cover element 22 and the cooler element 20. The controller board 18 can be formed, for example, as a printed circuit board and, in particular, carry electronic components of the helmet light 10 which are connected to one another via conductor tracks arranged on the controller board 18. These electronic components can include, in particular, a control controller, which is not explicitly represented, which controls the different functions of the helmet light 10, for example switching between several different operating modes and states, and switching on and off of the helmet light 10. It can also be provided that a small independent battery cell is provided on the controller board 18 which enables a short-term emergency operation of the helmet light 10 without an external battery pack 100. This emergency operation can be limited, for example, to a diagnostic operation and/or permit a rudimentary light output, for example for 10 min. Further, the controller board can carry a sensor unit, which is not represented in detail either, or can have a connection possibility for such a sensor unit, so that sensors of the most varied types comprised by the sensor unit can detect data, process them and send them to the control controller. Possible sensors of the sensor unit can comprise infrared, ultrasonic and twilight sensors. It is also possible to provide a backlight sensor and/or a gas sensor as a component of the sensor unit. In addition, the sensor unit can also comprise an acceleration sensor. Likewise, the sensor unit can comprise a body temperature sensor and/or a moisture sensor. The sensor unit can also comprise a head recognition sensor. It is also possible for the sensor unit to comprise a housing temperature sensor which detects a temperature of the helmet light 10. The sensors of the sensor unit can each be arranged integrated into the helmet light 10 or, optionally only partially, be provided as an external module, which can be arranged, for example, on the battery pack 100 or the ventilation slide 50.

The control controller can be set up, for example, to receive a detected housing operating temperature value and to change an operating state of the helmet light based on the received housing operating temperature value. For example, the control controller can be set up to reduce a light output of the helmet light 10 when the detected housing operating temperature value of the helmet light 10 exceeds a tolerable temperature threshold value T_{tol_max}. A reduction in the light output automatically means a reduction in the waste heat produced and thus a reduction in the housing operating temperature value in the long term. This can, for example, prevent ignition of the combustible material in an explosive environment (combustible gases or dust in the air). The control controller can also be set up to switch off the helmet light 10 after the output of a warning signal when the detected housing operating temperature value of the helmet light exceeds an upper temperature threshold value Tₘₐₓ. This may be necessary if, despite previously taken measures, a temperature reduction could not be achieved and a further temperature increase includes the immediate danger that the housing of the helmet light 10 acts as an “ignition spark” and could cause, for example, a dust or gas explosion. Likewise, the control controller can be set up to bring the switched-off helmet light 10 slowly into a selected operating state during a time interval Δt which is greater than the switching-on interval actually required for switching on the light-emitting elements, if the detected housing operating temperature value of the helmet light falls below a lower temperature threshold value T_{Leuchte_min}. This measure limits the amount of waste heat locally produced at the lighting elements at very low temperatures. This also reduces the resulting temperature gradients. In this way, less temperature-induced voltages are generated at the solder points and/or the printed circuit board, which could impair the functionality of the helmet light 10. Further, the control controller can be set up to continuously increase an actual light output of the helmet light 10 during the time interval Δt up to the light output desired in the selected operating mode. This also serves, for example, to reduce temperature gradients within the helmet light 10.

If the sensor unit comprises an infrared sensor, the sensor unit can be set up to detect sensor data from the infrared sensor, process them and send them as processed sensor data to the control controller. The control controller can in turn be set up to receive the processed sensor data and to switch the helmet light 10 between several operating modes and states based on the processed sensor data. The switching can take place whenever a predefined arm movement of a user wearing the protective helmet 30 is detected in the processed sensor data, for example a wave in front of the lens unit 14 at a certain speed. In this way, a simple control of the helmet light 10 can take place without the user needing particularly high attention for this purpose. If necessary, the user can even keep tools in their hand during the operating process.

The infrared sensor can be arranged on the controller board 18, for example in the vicinity of the LED elements 1610. Thus, the infrared sensor is then arranged in the area of the lens unit 14 and thereby detects sensor data substantially in an area in front of the lens unit 14. This permits a limitation/fixing of the control panel, so that an unintentional actuation of the helmet light 10 can be avoided. The sensor unit can also comprise an ultrasonic sensor, which can be arranged on the controller board 18 in the vicinity of the LED elements 1610 in a manner analogous to the infrared sensor. The advantages described in the context with the infrared sensor can also be realized with the help of the ultrasonic sensor in an analogous procedure. The ultrasonic sensor can thus also be arranged in the area of the lens unit 14 and can detect sensor data substantially in an area in front of the lens unit 14. This again makes it possible to restrict/fix the control panel, so that an unintentional actuation of the helmet light 10 can be avoided. The ultrasonic sensor is optionally also suitable for enabling operation by a user who is wearing special heat-insulating protective clothing. Thus, a switching can take place, for example, if a predefined arm gesture of a user wearing the protective helmet 30 is recognized in the processed further sensor data of the ultrasonic sensor. Instead of or in addition to the infrared and/or ultrasonic sensor, the sensor unit can also comprise a twilight sensor. The sensor unit can then be set up to detect sensor data of the twilight sensor, process them and send them as processed twilight data to the control controller. The control controller can in turn be set up to receive the processed twilight data and to switch the helmet light 10 between the several operating modes and states based on the processed twilight data, in particular to switch it on when insufficient brightness is recognized in the processed twilight data in front of the helmet light 10. This makes possible a partial automation of the operation of the helmet light 10, in particular the automated switching on. By arranging the twilight sensor in the area of the lens unit 14, sensor data are detected substantially in an area in front of the lens unit 14, in particular in an operating range. This makes it possible to restrict the automatic operation to the effect that an automatic actuation of the helmet light 10, in particular a switching-on, takes place only if an insufficient brightness is recognized in the area in front of the helmet light 10.

If the sensor unit comprises a backlight sensor, the sensor unit can be set up to detect sensor data from the backlight sensor, to process them and to send them as processed backlight sensor data to the control controller. The control controller can in turn be set up to receive the processed backlight sensor data and to switch the helmet light 10 between the several operating modes and states based on the processed backlight sensor data. This also permits a partial automation of the control of the helmet light 10. If the backlight sensor is directly struck by a light beam, i.e. the user is illuminated by another light source or another helmet light, it can be assumed that the helmet light 10 likewise illuminates the user of the other helmet light directly and optionally dazzles them. Accordingly, it is expedient to reduce the light output of the helmet light 10 of the user of the protective helmet 30 at least as long as the backlight sensor recognizes the directly incident light beam, preferably even a few seconds longer. Expediently, as already mentioned, the backlight sensor is part of the sensor unit and is arranged in the area of the lens unit 14 on the controller board 18, so that backlight sensor data are detected substantially in an area in front of the lens unit 14. On the basis of the usual arrangement of the helmet light 10 above the eye area of the user, it can then be assumed that recognition of a strong backlight in this area is also connected with a glare effect by the helmet light 10 for the carrier of the light source from which the backlight emanates. This is at least reduced in that, when the backlight is recognized, the helmet light 10 reduces its own light output.

In order to reduce the glare effect emanating from the helmet light 10, the control controller can be set up to switch the helmet light 10 from an operating mode in which a high beam is active into an operating mode or an operating state in which a light range and/or intensity of the high beam is at least adapted if it is recognized, based on the processed backlight sensor data, that an incident backlight exceeds or falls below a threshold brightness. A reduction of the glare effect emanating from the helmet light 10 is possible in particular by a reduction of the light beams reaching into the distance, for example of the high beam, by switching off, throttling the intensity or changing the direction of illumination, so that more light is illuminated in the direction of the ground. The control controller can then be set up to carry out the switching only if the incident backlight permanently exceeds or falls below the threshold brightness for a time interval Δt, wherein the time interval Δt is between 1 and 5 seconds, preferably between 2 and 3 seconds. In this way, it can be prevented that a light beam which only casually grazes the helmet light 10 and which does not characterize any real continuous glare of a counterpart, already triggers an adaptation of the operating mode or of the operating state of the helmet light 10. It is also possible for several mutually different threshold brightnesses to be predefined or adjustable in the control controller. The control controller is then set up to adjust the illumination range and/or intensity of the high beam in each case when one of the several mutually different threshold brightnesses is exceeded or undershot. In this way, an adequate illumination of an area in front of the user of the helmet light 10 can be combined with a glare effect which is as negligible as possible for other oncoming users with their own light sources. Instead of oncoming users with their own light source, a direction in which other users are located can also be determined, if appropriate, with the help of passive light sources, for example reflectors or the like, and/or position beacons which are carried by the other users. The term “user” is to be interpreted here very broadly and also comprises, in particular, animals, for example dogs, in particular working dogs, which, for example, in poor visibility conditions, help in a wounded game or, more generally, in a search and, in the case of this wounded game or search, could possibly be distracted by strong blinding light sources.

If the sensor unit comprises a gas sensor, the sensor unit can be set up to detect sensor data from the at least one gas sensor, to process them and to send them as processed gas sensor data to the control controller. The control controller can in turn be set up to receive the processed gas sensor data and to switch the helmet light 10 between the several operating modes and states based on the processed gas sensor data. By the fact that the helmet light 10 recognizes dangerous vapors via the gas sensor, at least one warning to the user can take place, so that the problem of the unconscious presence in an area contaminated by dangerous vapors is avoided. The gas sensor or sensors can be arranged in the area of a main body of the helmet light 10. The main body of the helmet light 10 has sufficient protected installation space for this purpose, which can be used for arranging the gas sensor or sensors. Other positions, for example on the ventilation slide, are also possible. The sensor unit can, for example, be set up with the help of the gas sensor to detect a concentration of CO₂ and/or CO. These gases are colorless and odorless and are particularly suitable for endangering the health of a user in an area contaminated with these gases in increased concentration. The control controller can then be set up to switch the helmet light 10 into an operating state in which a warning signal is output if the processed gas sensor data show a concentration of CO₂ and/or CO which is above a gas threshold concentration. The warning signal can be output acoustically and/or optically. An acoustic output can be output, for example, via a loudspeaker which can be coupled to the helmet light 10. The loudspeaker can, for example, be part of an input device which can be coupled to the helmet light 10. An optical output can mean, for example, the adaptation of the light color emitted by the helmet light 10. For example, the helmet light 10 can output or use a red light to illuminate the operating range in order to indicate the danger. By confronting the user with the warning signal, the user is given the opportunity to take measures to protect themselves, for example, to leave the endangered area. The sensor unit can also be set up to detect a concentration of a combustible gas via the gas sensor or sensors. Flammable gases can be ignited, for example, by the helmet light 10 itself or by a tool operated by the user. In this context, too, it can be provided that the control controller is set up to switch the helmet light 10 into an operating state in which at least one warning signal is output when the processed gas sensor data show a concentration of the combustible gas which is above a gas threshold concentration. The warning signal can again be output acoustically and/or optically. By confronting the user with the warning signal, the user is given the opportunity to take measures to protect themselves, for example, to leave the endangered area. Due to the risk of fire or explosion, provision can also be made after the warning signal to deactivate the helmet light 10 or at least to throttle the light output. This can prevent an explosion or deflagration, since the heating of the helmet light 10 and the associated battery pack 100 can already be sufficient for an ignition/explosion.

If the sensor unit comprises an acceleration sensor, the sensor unit can be set up to detect sensor data from the at least one acceleration sensor, to process them and to send them as processed acceleration sensor data to the control controller. The control controller can in turn be set up to receive the processed acceleration sensor data and to switch the helmet light 10 between several operating modes and states based on the processed acceleration sensor data. In the data of the acceleration sensor, a change in a movement trajectory of the user can be recognized, so that, for example, a fall of the user can be recognized by the control controller with the help of the sensor unit. The control controller can then take the suitable measures. The at least one acceleration sensor can be arranged in particular in the area of a main body of the helmet light 10. However, other positions, for example on the ventilation slide 50, are also possible. The main body of the helmet light 10 lies protected beneath the helmet shell, so that, based on the change in the movement trajectory, conclusions can be drawn in particular about the head movement of the user. This is particularly advantageous in order to recognize a fall in the acceleration data. The sensor unit or the acceleration sensor can detect an acceleration in three mutually non-parallel directions. This provides the most flexible possible data acquisition, which permits the detection, for example, of falls in any direction.

The control controller can be set up to switch the helmet light 10 into an operating state in which a position signal is output when the processed acceleration sensor data are above an adjustable acceleration threshold. If a fall of the user is thereby detected, characterized, for example, by an abrupt acceleration in the z-direction (height), the position signal can facilitate the localization of the user. The output of the position signal can in particular comprise switching on the helmet light 10, provided that it was previously switched off. The output of the position signal of the helmet light 10 can further comprise the activation of position-indicating light elements, for example one or more helicopter LEDs 4000, 4002a, 4002b. The output of a position signal can further also comprise a request to an input device coupled to the helmet light 10 to emit a position signal. If the input device is a mobile telephone or another input device equipped with a wireless communication possibility, the emission can comprise, for example, the emission of an emergency call via a radio communication channel, wherein the emergency call can optionally also comprise GPS coordinates of the input device if the input device has these. Helicopter LEDs 4000, 4002a, 4002b can be activated in particular as part of a helicopter light, wherein the helicopter light further improves a visibility of the user, in particular from above, for example from a helicopter or a crane. In principle, the helicopter light is advantageous in all cases where the user of the helmet light is/must be perceived by other persons who are at a significantly different height, which is also the case, for example, in the case of work on facades, earthworks in open pits, work in tree crowns and so on.

It is also possible to determine via the acceleration sensor or from the data supplied by the acceleration sensor whether the user is standing (no variation in the z-direction), walking (slow variation in the z-direction due to the pendulum movement at each individual step) or running (rapid variation in the z-direction). Based on this, it is possible to control the helmet light 10 by the control controller in such a way that a “light range” of the helmet light 10 is adjusted in dependence on this variation in the z-direction, for example working light when standing, short-range light when walking and long-range or long-range and short-range light when running. This can, for example, contribute to prevent a stumbling of the user.

If the sensor unit comprises an optionally contactless body temperature sensor, the sensor unit can be set up to detect sensor data from the at least one body temperature sensor, to process them and to send them as processed body temperature sensor data to the control controller. The control controller can in turn be set up to receive the processed body temperature sensor data and to switch the helmet light 10 between the several operating modes and states based on the processed body temperature sensor data. With the body temperature sensor, or the data detected by it, in particular an overheating or undercooling of the user can be recognized, which increases the safety of the user, since the user cannot always detect these states themselves in good time. By switching the helmet light 10, the user can be informed of their potentially hazardous state to their health. In this case, the switching can in particular also comprise switching on the helmet light 10. The at least one body temperature sensor can be arranged in the area of a main body of the helmet light 10. The main body of the helmet light 10 provides a protected installation space. In particular, the sensor unit can detect a body temperature at a head of a user when the user is wearing the protective helmet 30. From the main body, the body temperature sensor can carry out a direct temperature monitoring/measurement on the head of the user, which permits a good assessment of the general condition of the user. Alternatively, it is also possible to provide a body temperature sensor in the manner of a pulse belt directly on the body of the user and to connect it to the helmet light 10, for example by means of a radio interface of short range. The control controller can then be set up to output a warning signal when the processed body temperature sensor data exceed a predetermined body temperature threshold value tₘₐₓ. If this threshold value is exceeded, it can be concluded that the user is (imminently) being overheated. The warning signal can be output optically, for example by a changed light output of the helmet light 10, or acoustically, for example via a loudspeaker to be provided. If it can be seen from the detected body temperature sensor data that the user has suffered a heat stroke and needs help (a clear overheating is present or the detected body temperature rises further after the output of the warning signal, wherein other sensor data can additionally be taken into account), it can also be provided that the helmet light 10 outputs an emergency signal, as has already been described above in the context with a fall. The control controller can further be set up to output a warning signal when the processed body temperature sensor data fall below a predetermined body temperature threshold value tₘᵢₙ. If this threshold value is not reached, it can be concluded that the user is (imminently) undercooled. The warning signal can be output optically, for example by a changed light output of the helmet light 10, or acoustically, for example via a loudspeaker to be provided. If it can be seen from the detected body temperature sensor data that the user is already severely hypothermic and needs help (significant hypothermia is present or the detected body temperature drops further after the output of the warning signal, wherein other sensor data can additionally be taken into account), it can also be provided that the helmet light 10 emits an emergency signal, as has already been described above in the context with a fall.

If the sensor unit comprises a moisture sensor, the sensor unit can be set up to detect sensor data from the at least one moisture sensor, to process them and to send them as processed moisture sensor data to the control controller. The control controller can in turn be set up to receive the processed moisture sensor data and to switch the helmet light 10 between the several operating modes and states based on the processed moisture sensor data.

Switching between the several operating modes and states can here also explicitly comprise switching on the helmet light 10. Further, an increase in the proportion of yellow in the emitted light can also be provided in order to be able to better illuminate any possibly present fog-like haze or fog. The at least one moisture sensor can be arranged in the area of a main body of the helmet light 10. The main body of the helmet light 10 provides a specially protected installation space. Other positions, for example on the ventilation slide 50, are also possible.

The helmet light 10 can comprise a fan unit and the control controller can in this case be set up to switch the fan unit on or off if the processed moisture sensor data exceed or fall below a predetermined moisture threshold value. When the fan unit associated with the helmet light 10 is activated, an air flow can be generated in particular under the helmet shell 36 of the protective helmet 30 in order to better transport away any sweat film which may be present, which increases the wearing comfort of the protective helmet 30 and lowers the body temperature of the user. The fan unit can be arranged, for example, on the main body of the helmet light 10 or on the lower rim of the helmet shell 36. The fan unit is not represented in the figures, but it is obvious to a person skilled in the art how it must be designed so that it can generate an air flow below the helmet shell 36. Alternatively, the fan unit can also be arranged on or in the ventilation slide 50 and suck or blow the air flow through the ventilation openings 53 provided there. The fan unit can be supplied with electrical energy via the helmet light 10 or directly from the battery pack 100. The control controller can further be set up to output a warning signal when the processed moisture sensor data exceed a predetermined moisture warning threshold value. In this “warning level”, the user can be informed that the humidity in the ambient air may soon reach a problematic level.

If the sensor unit comprises a head recognition sensor, the sensor unit can be set up to detect sensor data from the at least one head recognition sensor, process them and send them to the control controller as processed head recognition sensor data, wherein the control controller is set up to receive the processed head recognition sensor data and to switch the helmet light 10 between the several operating modes and states based on the processed head recognition sensor data. In this way, a partial automation of the control of the helmet light 10 can be achieved. Further, the several operating modes and states also explicitly comprise the switching on and off of the helmet light 10 as well as further operating modes, in particular controlled based on the detected data from the head recognition sensor. It can be provided that the head recognition sensor is arranged in the area of a main body of the helmet light 10. The main body of the helmet light 10 represents a protected installation space. Further, the main body is arranged under the helmet shell of the protective helmet 30 and thus automatically in the vicinity of the head of the user, so that recognition is relatively simple.

The head recognition sensor can comprise a position sensor which, as part of the head recognition sensor data, detects a spatial position of the helmet light 10, processes it and sends it to the control controller. By recognizing the spatial position of the helmet light 10, it is possible to draw a rough conclusion as to whether the user is wearing the protective helmet 30 at all or what they are doing. Thus, the user will keep the helmet light 10 standing substantially “horizontally” for most of the time. The control controller can then be set up to activate a working light of the helmet light 10 when it is apparent from the head recognition sensor data that the helmet light 10 points to the ground. If the user, starting from a “horizontal orientation” of the helmet light 10, inclines the head forward when looking straight in order to perform an activity directly in front of them, the helmet light 10 is also inclined forward, so that activation of the working light of the helmet light 10 is useful and can be carried out automatically by the control controller. In an analogous manner, the control controller can also be set up to activate a high beam of the helmet light 10 if it is apparent from the head recognition sensor data that the helmet light 10 points parallel to the ground or to the sky. The head recognition sensor can also comprise a distance sensor which, as part of the head recognition sensor data, detects distance data, processes them and sends them to the control controller. The distance data can be detected in particular within the helmet shell. In this context, the control controller can be set up to activate a working light or another light of the helmet light 10 when the head recognition sensor data show that the user is wearing the protective helmet 30. This also contributes to a useful automation of the control of the helmet light 10.

If the sensor unit comprises a housing temperature sensor which detects a housing operating temperature value of the helmet light 10, the control controller can be set up to receive the detected housing operating temperature value and to change an operating state of the helmet light 10 based on the received housing operating temperature value. As a result, for example, the heat development of the helmet light 10 can be limited in order to influence the detected housing operating temperature in a desired manner, in particular to limit it upwards. The control controller can be set up, for example, to lower a light output of the helmet light 10 when the detected housing operating temperature value of the helmet light 10 exceeds a tolerable temperature threshold value T_{tol_max}. As a result, less electrical energy is converted into light, so that less waste heat which increases the housing temperature is also generated. As a further example, it should be noted that the control controller can be set up to switch off the helmet light 10 after the output of a warning signal when the detected housing operating temperature value of the helmet light 10 exceeds an upper temperature threshold value Tₘₐₓ. This procedure can directly contribute to prevent an explosion by presetting the temperature threshold value below an “ignition temperature”, for example to 40 °C. Depending on the gas and dust particles to be expected in the ambient air, the temperature threshold value can be set differently in order to reliably comply with legal requirements for explosion protection. The warning signal can again be output, for example, optically or acoustically, as has already been described above. The control controller can also be set up to bring the switched-off helmet light 10 into a selected operating mode during a time interval Δt when the detected housing operating temperature of the helmet light 10 falls below a lower temperature threshold value T_{Leuchte_min}. Due to the slow heating, thermal stresses within the helmet light 10, in particular on the controller board and the solder points located thereon, are avoided. In addition, the control controller can be set up to continuously increase an actual light output of the helmet light 10 during the time interval Δt up to the light output desired in the selected operating mode. Since cracks are more likely to be created at very low temperatures than at higher temperatures, it is expedient to generate a smaller amount of waste heat at the beginning of the respective operating cycle when the helmet light 10 is still comparatively cold. It is likewise possible again for the helmet light 10 to comprise a battery pack 100 with a temperature sensor which detects a battery pack operating temperature of the battery pack 100, wherein the helmet light 10 comprises a control controller which is set up to receive the detected temperature value and to change an operating state of the helmet light 10 based on the received battery pack operating temperature value. In this way, the control controller can take suitable measures so that the battery pack 100 is kept within a tolerable temperature range, as already explained above. The control controller can further be set up again to activate an electrical heating unit arranged in a battery body 194 as long as the detected battery pack operating temperature value of the battery pack 100 falls below a lower temperature threshold value T_{Akku_min}. In this way, the discharge cycle of the battery pack 100 can take place with the otherwise usual parameters. The control controller can also be set up again to lower a light output of the helmet light 10 when the detected battery pack operating temperature value of the battery pack 100 exceeds a tolerable temperature threshold value T_{Akku_max}. By lowering the light output, i.e. a reduction in the brightness of the helmet light 10, the electrical power taken from the battery pack 100 is reduced, which directly causes a reduction in the waste heat produced, so that the temperature of the battery pack 100 can fall, wherein a constant rate of emission of the waste heat to the environment is assumed. This can be advantageous, for example, in an environment at risk of explosion.

The above-described actions of the different sensors, the sensor unit comprising these sensors, and the control controller can also be regarded as a method that is executed by these different elements of the helmet light 10. Further, it is possible to adapt the behavior of the helmet light 10 to different application purposes, for example by “reprogramming” individual or all threshold values, changing/adapting the recognized gestures/arm movements and the functions triggered thereby, etc.

The controller board 18 is arranged mainly in the area of the main body of the helmet light 10, but projects beyond the main body in its rim area pointing forward in FIG. 3a. The controller board 18 is backed by a carrier element 16 over its entire surface, in particular completely, in order to guarantee sufficient mechanical stability of the controller board 18. As can be recognized in FIG. 3a, the rim areas of the controller board 18 and of the carrier element 16 can be formed to be angled with respect to their central areas, wherein the laterally located angled areas of the controller board 18 are able to carry, for example, the plug connection 3000 already known from FIGS. 2a to 2f and the connecting plug connection 3002, which are not represented in FIGS. 3a and 3b for the sake of simplicity. In FIG. 3a, the controller board 18 and the carrier element 16 continue forward in the direction of the lens unit 14 and thus connect the latter to the main body of the helmet light 10. The controller board 18 can, for example, carry LED elements 1610 which generate visible light and which are connected to a corresponding energy source via electrical connecting lines on the controller board 18. The lens unit 14 comprises some lens elements which are not provided with separate reference numerals. Each of these lens elements can be assigned to one or more light-generating LED elements 1610 on the controller board 18. The lens elements bundle and focus the light emanating from the LED elements 1610 in the desired radiation direction. In front of the lens unit 14, a cover 12 can also be recognized, which can be designed to be exchangeable, for example. The cover 12 serves substantially to protect the lens unit 14, the individual lens elements of which are sensitive to mechanical damage, in particular scratches.

It can be provided that the helmet light 10, for example on the controller board 18 or on an outer side of the helmet light 10, has a housing temperature sensor which is not explicitly represented. This housing temperature sensor can detect in particular a housing operating temperature value of the helmet light 10.

FIG. 3b shows a three-dimensional representation of parts of a helmet light 10 from obliquely below. In FIG. 3b, in particular the cooler element 20 with its heat-dissipating cooling ribs 21 and the further reinforcing circumferential bead can be recognized. Further, the centrally arranged switch 120 is also again visible. In the front area of FIG. 3b, a recess 25 is also provided on the cooler element 20, which is located in the area of the connector plug 3000 to be arranged there on the controller board 18, in order to protect it from excessive mechanical loading. On the opposite side, a corresponding recess on the cooler element 20 is not visible, but can nevertheless also be provided for the connecting plug connection 3002 to be arranged there.

The cooler element 20 is connected in a planar manner to the carrier element 16 which it covers, so that heat generated during the operation of the helmet light 10 passes from the controller board 18 through the carrier element 16, which is formed as a good heat conductor, to the cooler element 20 and is discharged therefrom into the surroundings.

FIG. 3c shows a further three-dimensional representation of parts of a helmet light 10 from obliquely above. In the representation chosen in FIG. 3c, only the controller board 18, the carrier element 16 arranged underneath and the cover 12 are visible. The cover 12 in turn covers the lens unit 14 which is usually arranged underneath and which in turn covers LED elements 1610 on the controller board 18. In the central area of the controller board 18, through-holes, not designated in more detail, can also be recognized, through which the cooler element 20 can be screwed together with the cover element 22 during the mounting of the helmet light 10. The through-holes accordingly also extend through the carrier element 16.

FIG. 3d shows further components of a helmet light 10 three-dimensionally from obliquely above. Compared to FIG. 3c, FIG. 3d additionally represents the cover element 22 arranged on the controller board 18. The upper side of the cover element 22, which is visible in FIG. 3d, with the on/off switch, which is not designated in more detail, faces the helmet shell 36 in the mounted state of the helmet light 10.

FIG. 3e shows components of the helmet light 10 three-dimensionally from obliquely below. At the viewing angle selected in FIG. 3e, the cover element 22 lies on the underside of the helmet light 10, which faces away from the observer, and the cover element 22 is thus only partially visible. Further, representation of the cooler element 20 was dispensed with so that the carrier element 16 located underneath is now visible. The controller board 18 is largely covered by the carrier element 16, so that only a few edges of the controller board 18 are visible. The plug connection 3000 and the connecting plug connection 3002 are further represented at the laterally angled areas of the controller board 18. The through-holes in the controller board 18 as well as their continuation in the carrier element 16 can also be recognized. In addition, from this view angle, further through-holes can now be recognized in the angled front area, which also serve mounting purposes. In addition, the switch 120 is again visible centrally on the carrier element 16 and can now be recognized resting directly on the carrier element 16 and, if the cooler element 20 is mounted, is framed by it in a “half-moon-like” manner. The switch 120 can be formed in particular in the form of a foil switch, wherein in particular foil-like connecting lines are guided around an edge of the carrier element 16 and connect the switch to corresponding connections on the controller board 18.

FIG. 4a shows a lens unit 14 of the helmet light 10 from behind and FIG. 4b shows the lens unit 14 of the helmet light 10 from the front. The lens unit 14 has a number of directional units 1402 arranged next to one another. 7 individual directional units 1402 arranged next to one another are represented. The respective directional units 1402 serve for guiding light within the lens unit 14. The directional units 1402 are of frustoconical design, wherein each of the directional units 1402 is assigned to a separate LED element 1610 and light emitted by the LED element 1610 passes through the lens unit 14 from the rear to the front, wherein as little scattered light to the side as possible is desired. This can be realized or at least supported, in particular, by the frustoconical design of the directional units 1402, wherein light emitted by the respective LED elements 1610 is refracted back into the frustoconical shape by the natural beam refraction at the boundary areas between the directional unit and the intervening free space. An additional reflective coating of the frustoconical surfaces is conceivable and can be provided if required. The light emerging at the front side of the lens unit 14 at the respective directional units 1402 first passes there into the area of different Fresnel lenses 1400a, 1400b and 1400c, wherein each one of the directional units 1402 forms a pair with one of the Fresnel lenses 1400a, 1400b and 1400c and opens into the latter. The different Fresnel lenses 1400a, 1400b and 1400c are of different design, wherein the three centrally arranged Fresnel lenses 1400c each have different main radiation directions from the pairs of the Fresnel lenses 1400b and 1400a arranged further outwards. It is of course possible to form the lens unit 14 with more or less pairs of directional units 1402 and Fresnel lenses 1400a, 1400b and 1400c. Further, the provided main beam directions of the individual Fresnel lenses 1400a, 1400b and 1400c can also be formed as required. For example, the different main beam directions of the Fresnel lenses 1400a, 1400b and 1400c can be designed in such a way that the Fresnel lenses 1400a are outer working light lenses, the Fresnel lenses 1400b are inner working light lenses, and the Fresnel lenses 1400c are front light or high beam lenses. The lens element 14 can be formed, for example, as an injection-molded part of transparent plastic with suitable light refraction properties. Individual Fresnel lenses 1400a, 1400b, 1400c can in particular also have the function of a diffuser.

The different Fresnel lenses 1400a, 1400b, 1400c are used in the various operating modes of the helmet light 10 in different combinations for radiating light in order to illuminate the light cones desired for the respective operating mode for illuminating the different spatial areas, in particular the operating range, the short range and the long range, around the helmet light 10.

The room area located directly in front of the user, for example, can be regarded as the operating range of the user. A core area of the illuminated operating range, i.e. the light cone or cones which emanate from the Fresnel lenses 1400a, 1400b, 1400c and illuminate an area directly, can, for example, begin about 1 m in front of the user and end about 4 m in front of the user at an assumed height of the protective helmet 30 worn by the user of 1.8 m and an orientation of the protective helmet “parallel” to the ground. A lateral opening angle, starting from the helmet light 10, of the core area of the illuminated operating range can be about 160°, so that to the right and left a wide area lies directly within the light cone or cones. From this, a main beam direction and a shape of the light cone or cones, which originate from the “active” Fresnel lenses, can be determined in a simple manner, which directly illuminate the core area of the operating range. Further, the operating range can be defined in this way, wherein the exact limits of the light cone or cones can still be modified depending on the application case. The shape and limit of the light cone or cones is determined by the Fresnel lenses 1400a, 1400b, 1400c used, which each have a main beam direction and an optionally “asymmetrical” radiation angle. By illuminating the operating range, on the one hand, a narrowly limited area in front of the user of the helmet light 10 is illuminated broadly, which simplifies their work. At the same time, a possible glare effect is prevented for further persons working in the vicinity of the user.

The short range adjoining the operating range in the distance can, for example, still overlap in parts with the operating range and in particular be illuminated when the user wearing the protective helmet 30 is walking. The core area of the illuminated short range, i.e. the light cone or cones emanating from the helmet light 10, which illuminates an area directly, can, for example, begin about 2 m in front of the user at an assumed height of the protective helmet worn by the user of 1.8 m and an orientation of the protective helmet 30 “parallel” to the ground and end about 6 m in front of the user. A lateral opening angle, starting from the helmet light 10, of the core area of the illuminated short range can lie at about 120°, so that to the right and left an area which is somewhat less wide than the operating range lies directly within the light cone or cones. From this, a main beam direction and a shape of the light cone or cones can again be determined in a simple manner, which directly illuminate the core area of the short range. In this way, the operating range is closer and, just like the short range, sufficiently defined. The shape of the light cone or cones is again determined by the Fresnel lenses 1400a, 1400b, 1400c used, which each have a main beam direction and an optionally “asymmetrical” radiation angle. By illuminating the short range, a limited area in front of the user of the helmet light 10 is well illuminated, which permits a reliable and timely recognition of obstacles during walking. At the same time, a possible glare effect is kept small for further persons working in the vicinity of the user.

The space area in front of the user, which extends far beyond the short range into the distance, can be defined as the long range of the user. The long range can, for example, still overlap in parts with the operating range and, in particular, be illuminated when the user wearing the protective helmet 30 runs or “looks into the distance”, that is to say looks into the “distance” with their head raised. This can be detected, for example, with the help of a position sensor. The core area of the illuminated long range, i.e. the light cone or cones emanating from the helmet light 10, which illuminates an area directly, can, for example, begin approximately 5 m in front of the user at an assumed height of the protective helmet worn by the user of 1.8 m and an orientation of the protective helmet “parallel” to the ground, and end approximately in infinity, and even point upwards to the sky, so that the illuminated core area does not formally end in front of the user, but extends into infinity. However, in order to reduce a possible glare effect, it can be provided that the light cone emanating from the helmet light 10 strikes the ground at a distance, for example at a distance of 100 m. A lateral opening angle, starting from the helmet light, of the core area of the illuminated long range can be about 60° or less, so that only a small area lies directly within the light cone or cones to the right and left. From this, a main beam direction and a shape of the light cone or cones can again be determined in a simple manner, which directly illuminate the core area of the long range. Further, the long range can be defined sufficiently in this way. The shape of the light cone or cones is again determined by the Fresnel lenses used, which each have a main beam direction and an optionally “asymmetrical” radiation angle. By illuminating the long range, an area far in front of the user of the helmet light 10 is illuminated, which permits reliable and timely recognition of objects further away.

The lens unit 14 can further have, at the lower rim of its rear side, areas which permit a diffuse exit of light in the direction of the face of a user when an assigned LED element 1610 emits light. This diffuse light can, in particular, constitute the essential part of a facial illumination.

The lens unit 14 thus comprises a plurality of Fresnel lenses 1400a, 1400b, 1400c, which are arranged substantially next to one another. The exact number of the plurality of Fresnel lenses 1400a, 1400b, 1400c can be adjusted as required. The plurality of Fresnel lenses 1400a, 1400b, 1400c can also be divided into a first and a second subset of Fresnel lenses 1400a, 1400b, 1400c. The first subset of Fresnel lenses 1400a, 1400b, 1400c can then emit light, for example, when an illumination of an operating range of the user of the protective helmet 30 takes place when the user wears the protective helmet 30. The second subset of Fresnel lenses 1400a, 1400b, 1400c can, in turn, emit light when illumination of a long range of the user of the protective helmet 30 occurs when the user wears the protective helmet 30. In this way, different areas can be illuminated by the helmet light 10 without the helmet light 10 itself or a protective helmet 30, to which the helmet light 10 is fastened, being moved. Individual lenses of the plurality of Fresnel lenses 1400a, 1400b, 1400c can also comprise the function of a diffuser to counteract a possible glare effect. This can apply in particular to the components of the helmet light 10 which are used for illumination of a face area of the user. Light can be emitted via a part of the first subset of Fresnel lenses 1400a, 1400b, 1400c, while light is also emitted via a part of the second subset of Fresnel lenses 1400a, 1400b, 1400c, for example in order to realize illumination of a short-range area of the user of the protective helmet when the user wears the protective helmet 30. In this way, a stepped, gradual transition in the illumination between the operating range and the long range can be achieved, in order to illuminate, for example, a short range located between the operating range and the long range and partially overlapping with the operating range and the long range. A glare shield surrounding the lens unit 14 can be provided in order to prevent light from the lens unit 14 from accidentally falling directly onto the user's face, in particular into the user's eyes. The lens unit 14 can consist of a transparent material which attenuates yellow light least in the visible frequency range. It is also conceivable as an alternative that a cover 12 is removably arranged in front of the lens unit 14 as part of the lens unit 14, which consists of such a transparent material which attenuates yellow light least in the visible frequency range. If the yellow portion of the light generated by the helmet light 10 is least attenuated, the yellow portion in the emitted light, which has a “more yellow” effect, is consequently increased. In this way, fog in particular can be better illuminated, since this visible yellow light scatters less strongly than visible light in other colors. As already mentioned, individual Fresnel lenses 1400a, 1400b, 1400c of the plurality of Fresnel lenses 1400a, 1400b, 1400c can have different main beam directions from one another. In this way, light generated by the helmet light 10 can be bundled in different directions in order to illuminate different areas around the user of the helmet light 10. Individual Fresnel lenses 1400a, 1400b, 1400c of the plurality of Fresnel lenses 1400a, 1400b, 1400c can bundle emitted light to different degrees. Optionally, individual lenses can also act as scattering lenses which fan out light beams generated by LED elements 1610 in order to achieve a less point-like illumination. This permits a “bright” illumination which varies according to the requirements and in particular also permits a rather diffuse illumination of an area, for example in order to counteract a glare effect.

FIG. 5a shows a controller board 18 of the helmet light 10. As already mentioned, the controller board 18 has conductor tracks 1608 which are not represented in FIG. 5a for the sake of simplicity. Only a few electronic elements in the central area of the controller board 18 are indicated. A mechanical switching element 1612, which can be provided for operating the helmet light 10, is indicated in particular in the center. The lateral areas of the controller board 18 are represented as angled with respect to the central area, wherein, in order to realize this angling, millings 1602 are provided on which the controller board 18 can be bent into the desired shape. A plurality of bores 1604 is also arranged distributed over the controller board 18, which can, for example, help to fasten the cooler element 20 and the cover element 22 during assembly. In the angled front area, light-emitting LED elements 1610 are further indicated. The LED elements 1610 can vary in their number and in their properties. For example, the lens unit 14 can be formed with “more” Fresnel lenses 1400a, 1400b, 1400c and the number of LED elements 1610 can be correspondingly increased. It is also possible for the LED elements 1610, or at least some of them, to be colored LED elements 1610 whose luminous color can be adjusted. In addition to the represented LED elements 1610, which belong to the individual Fresnel lenses 1400a, 1400b, 1400c of the lens unit 14, the controller board 18 can also comprise further LED elements, not represented, which emit light in the direction of a lower rim of the controller board 18 or of the lens unit 14, which emerges there as diffuse light and can make up the essential part of the face illumination.

FIG. 5b shows a carrier element 16 of the helmet light 10 three-dimensionally from one side, while FIG. 5c shows the same carrier element 16 three-dimensionally from the opposite side. It can be recognized that the carrier element 16 is provided with bending points 1804, which delimit the central area of the carrier element 16 from the angled lateral areas, as well as various bores 1806, which in particular can coincide with the bores 1604 on the controller board 18 in their respective positions. In the central area of the carrier element 16, a large recess can also be recognized, with the help of which the switch in the form of a mechanical switching element can be arranged directly on the controller board 18 and at the same time become accessible through the carrier element 16. However, this recess is optional and a switch, which may be desired, on this side of the controller board 18 or of the helmet light 10 can alternatively be formed as a foil switch without the recess. In this case, connecting lines are then led around the carrier element 16 to the controller board 18. The carrier element 16 can be milled or punched, for example, from an aluminum sheet and bent into the desired shape. The carrier element 16 can, for example, be glued to the controller board 18, so that the controller board 18 and the carrier element 16 form a unit and heat emanating from the controller board 18 can be easily dissipated via the carrier element 16.

FIG. 6a shows a controller board 18 of a helmet light 10 from one side, while FIG. 6b shows the same controller board 18 of the helmet light 10 from another side opposite the side. In the controller board 18 represented in FIGS. 6a and 6b, the plug connection 3000 and the connecting plug connection 3002 are additionally represented on the opposite laterally angled area. Further, FIG. 6a represents, by way of example, a mechanical switching element 1612 on the controller board 18 and the LED elements 1610 arranged on the angled area facing away from the observer are likewise still recognizable, which likewise applies to a rim of a framing 1616, which is described in more detail in the context with FIG. 6b. In FIG. 6b, a further mechanical switching element 1614 can be recognized on the other side of the controller board 18, which is enclosed by the framing 1616, which on the one hand can serve as an assembly aid for the carrier element 16 (centering function together with the central recess on the carrier element 16) and on the other hand protects the further mechanical switching element 1614 from unacceptable forces. The framing 1616 can also frame further electronic components, for example capacitors and/or resistors, on the controller board 18 and protect them from mechanical forces. Alternatively, the side of the controller board 18 visible in FIG. 6b can also be designed without the further mechanical switching element 1614 in an embodiment which is not represented, so that the associated/matching carrier element 16 can then optionally be designed without the central recess. In this case, for example, a foil switch can be provided, the connection of which can be guided around the rim of the carrier element 16 from the controller board 18 to the side of the carrier element 16 facing away from the controller board 18, in order to realize the function of the further mechanical switching element 1614 there. In a similar manner, the mechanical switching element 1612 represented in FIG. 6a can also be replaced, for example, by a foil switch or another switching element.

FIGS. 7a, 7b and 7c each show a ventilation slide 50 of a protective helmet 30 from different viewing directions. FIG. 7a shows the ventilation slide 50 from above. FIG. 7b shows the ventilation slide 50 from the side and FIG. 7c shows it from obliquely behind. The ventilation slide 50 is usually fixed displaceably to a helmet shell 36 of a protective helmet 30, for example clipped in with the help of a detent device, wherein detent lugs of the detent device, which can be arranged, for example, on the ventilation slide 50, then are movable/displaceable within a channel in a helmet shell 36 of the protective helmet 30 together with the ventilation slide 50 relative to the protective helmet 30, so that ventilation openings 53, which can be recognized in FIGS. 7a to 7c, coincide with associated openings on the helmet shell 36 of the protective helmet 30, or are offset with respect thereto. In the offset position, the ventilation openings 53 are closed (by the material of the helmet shell 36), while in the other position, that is to say the corresponding position, the ventilation openings 53 are open, so that an exchange of air can take place between the interior of the helmet shell 36 and the outer space above the helmet shell 36. The ventilation slide 50 represented in FIGS. 7a to 7c comprises, in addition to the ventilation openings 53, several helicopter LEDs 4000, 4002a, 4002b arranged centrally. When the ventilation slide 50 is mounted on the helmet shell 36, and the helmet shell 36 is worn as part of a protective helmet 30 by a user, the helicopter LEDs 4002a and 4002b are directed substantially upward when the user is standing, so that the user can be easily located from above in the dark. The helicopter LED 4000 is located behind an edge 4004 with an inclined orientation relative to the two further helicopter LEDs 4002a and 4002b, so that the beam direction of the helicopter LED 4000 is also inclined relative to the further helicopter LEDs 4002a and 4002b. In this way, if the ventilation slide 50 is worn by a user as part of a protective helmet 30, a localizability can also be achieved from above by the helicopter LED 4000 in the case of a user bent forward or in the case of a lying user (for example after a fall). In the case of an upright user, the helicopter LED 4000 can be regarded or used as a “position light” radiating to the rear. Depending on the requirements, further LEDs can be provided on the ventilation slide 50, for example in order to ensure localizability of the user, who is wearing a protective helmet 30 with such a ventilation slide 50, also in lateral directions. By providing further LEDs on the sides of the ventilation slide 50 in different, easily distinguishable colors, an orientation or a viewing direction of the user can also be displayed at least roughly. For example, a first LED arranged on a left side when wearing the protective helmet 30 can radiate in a first color, and a second LED arranged on a right side when wearing the protective helmet can radiate in a second color, which is different from the first color, so that it becomes apparent to a distant observer, even in the dark, whether they are facing the left side of the head or the right side of the head of the wearer of the protective helmet 30, from which they can in turn draw conclusions about the approximate viewing direction of the wearer of the protective helmet 30.

The helicopter LEDs 4000, 4002a and 4002b arranged in the ventilation slide 50 can, for example, be electrically connected to the helmet light 10, in particular via an electrical connecting line which is connected, for example, to the helmet light 10 at the connecting plug connection 3002 already known from FIG. 1 or to the connecting connection 3002a.

Further, at least one battery cell can be arranged on the invisible inside of the ventilation slide 50. In this way, the battery cell can be arranged in a protected and fixed position, so that in particular an unintentional stripping or hanging on obstacles can be reliably excluded. The ventilation slide 50 can further comprise a curved ventilation slide bottom which is not visible from the viewing directions represented and which substantially forms the inside of the ventilation slide and abuts with its rim against the inside of the ventilation slide outside and thereby forms a space volume in the ventilation slide 50 in which the at least one battery cell is arranged. In this way, it is possible to realize an encapsulation of the battery inside the ventilation slide 50 so that it is even better protected.

The ventilation slide 50 can further comprise an electrical connection which is used for connecting the at least one battery cell to an electrical consumer and/or an electrical charging source. The electrical connection thus permits, just like the connection of the battery pack 100 described in more detail below, a standardized connection between the battery cell in the ventilation slide 50 and the helmet light 10 or another electrical consumer. The electrical connection can be arranged on a lower rim of the ventilation slide outside, so that an easy access or an easy electrical connection possibility is realized.

The electrical connection can be oriented and arranged in such a way that it can be displaced together with the at least one detent lug in the groove on the helmet shell 36. In this way, it is possible to guide the connection cable 24 completely underneath the helmet shell 36, so that there are no outwardly facing cable loops which could endanger the safety of the user. Alternatively, it is possible for the electrical connection to be oriented and arranged in such a way that it can be displaced parallel to the at least one detent lug in a further groove on the helmet shell 36. In this way, it is also possible to guide the connection cable 24 completely underneath the helmet shell 36, so that there are no outwardly facing cable loops which could endanger the safety of the user.

Magnets and electrical contacts can also be provided in the context with the electrical connection, wherein the advantages are analogous to the respective features in the context with the connector plug 192 described later. The magnets make it possible, in particular, to facilitate the blind connection of the connector plug to the battery cell, since the magnets pull the components of the plug connection into the correct position. A further electrical connection separate from the electrical connection which interacts with the electrical connection can also be provided. The further electrical connection can be arranged on a lower rim of the ventilation slide outside so that it is easily accessible and a simple connection of a charging device to the battery cell is realized.

It is further conceivable that the further electrical connection comprises magnets and electrical contacts. The magnets also make it possible at this point to facilitate the blind connection of a plug for charging the battery pack, since the magnets pull the components of the plug connection into the correct position.

FIGS. 8a to 8i each show three-dimensional external views of a battery pack 100. The representations are partially simplified, so as not to be dominated by insignificant details. FIG. 8a shows the battery pack 100 in the deactivated state. The battery pack 100 represented in FIG. 8a comprises a substantially elongated and cuboid battery body 194, the edges of which are beveled, as represented in FIG. 8a. Rounding of the edges is also conceivable as an alternative. On one side of the battery body 194, a display and operating element 102 in the inactive state is represented in FIG. 8a. In the lower area of the battery pack 100, a connector plug 192 can be recognized, which is already known from FIG. 1. The battery pack 100 can be connected to the helmet light 10 with the help of the connector plug 192. In FIG. 8a, the battery pack 100 is represented in its deactivated state, so that consequently the display and operating element 102 shows “nothing”. However, it is conceivable that the display and operating element 102 can be used for switching individual display elements on and off on the display and operating element 102 and can accordingly also be “labeled” in order to also identify the operating element without current.

FIG. 8b shows the battery pack 100 from a side which is opposite the display and operating element 102 from FIG. 8a, so that the rear side of the battery pack 100 is visible. The rear side of the battery pack 100 can be structured in different ways as needed.

FIG. 8c shows the battery pack 100 in an activated state. The display and operating element 102 from in FIG. 8a, which is not separately designated, shows various information for a user, in particular when the battery pack 100 itself is activated. The display and operating element 102 can, for example, graphically represent a temperature display 2000, a battery charging level display 2002, and an on/off button 2004, optionally with an LED backlight 2006. For this purpose, the display and operating element 102 can have a display area 2008, under which an on/off switch element, in particular as a foil switch, can be arranged, so that touching the represented on/off switch 2004 can, for example, cause the battery pack 100 or the connected helmet light 10 to be switched on and off. The temperature display 2000 can, in particular, graphically represent the temperature of the battery pack 100. This may be important because the capacity and output performance of the battery pack 100 varies with temperature. The display area 2008 can, of course, optionally also graphically represent other or further information on the helmet light 10 or on the battery pack 100. For example, in the display area 2008, error messages of the helmet light 10 could be graphically represented if the battery pack 100 is coupled to the helmet light 10 via the connector plug 192. Below the connector plug 192, a charging plug 190 can also be recognized in FIG. 8c. The charging plug 190, as represented in FIG. 8c, can be coupled to the battery pack 100 when the connector plug 192 is interposed. Alternatively, it is also possible for the battery pack 100 to be coupled directly to the charging plug 190 without an interposed connector plug 192. The LED backlight 2006, which is indicated in FIG. 8c by a hatching around the on/off button 2004, can also provide a “rear light function” for the user, for example, if required, since the alignment of the battery pack 100 in the mounted state on the protective helmet 30 permits a corresponding functionality. Alternatively or additionally, one or more, in particular red, LEDs can be separately provided on the housing of the battery body 194.

The external view of the battery pack 100 shown in FIG. 8d corresponds to FIG. 8c with respect to the viewing angle represented. Compared with FIG. 8c, however, the battery pack in FIG. 8d is represented in a different operating state. In the case of the battery pack 100 represented in FIG. 8c, the LED backlight 2006 is activated, which is indicated by the hatching used. In the case of the battery pack 100 represented in FIG. 8d, the LED backlight 2006 is deactivated, which is indicated by the absence of hatching. In the same way, in the area of the battery charging level display 2002, recognizable hatches can visualize the current charge level of the battery pack 100. The temperature display 2000 can, for example, visualize the temperature of the battery pack 100 with the help of a color change or in another suitable manner. Alternatively, it is also conceivable that in the vicinity or instead of the symbol recognizable in FIG. 8d, the temperature display 2000 directly represents the temperature of the battery pack 100 in figures. The on/off button 2004 represented, for example, in FIGS. 8c and 8d can provide different functions. For example, the on/off button 2004 can switch a helmet light 10 connected to the battery pack 100 on or off. As long as no helmet light 10 is connected to the battery pack 100, the on/off button 2004 can, for example, place the battery pack 100 itself in different operating states, for example it can be provided to interrogate at least some of the information which can be displayed on the display area 2008 with its help and in particular to activate or deactivate the battery charging level display 2002. The change of the functions provided by the on/off button 2004 can be effected as a function of the plugs respectively connected to the battery pack 100, i.e. the charging plug 190 and the connector plug 192, wherein an internal logic circuit of the battery pack 100 recognizes, based on measurable voltages at the connecting contacts of the battery pack 100 described in more detail below, which plugs are connected to the battery pack 100. The special design of the charging plug 190 and the connector plug 192 permits the simultaneous connection of the connector plug 192 and the charging plug 190 to the battery pack 100, so that in this way, for example, also several batteries can be connected simultaneously to the helmet light 10 of the helmet light system. Further, the charging of the battery pack 100 during the use of the helmet light 10 is also possible.

The helmet light system can, in addition to the helmet light 10, which can be switched in several operating modes and states, comprise a transmitting and receiving module and an input device with a further transmitting and receiving module. The input device can then be connected to the helmet light 10 via the transmitting and receiving module and the further transmitting and receiving module in the form of a 2-way communication. As a result, the helmet light 10 can be controlled via the input device and the input device can also receive operating information from the helmet light 10 in the reverse direction when the helmet light 10 is connected to the input device. In this way, the input device can be positioned as an operating unit for the helmet light 10 as desired and can be arranged, in particular, in the view of the user, so that the operation of the helmet light system is simplified. The transmitting and receiving module and the further transmitting and receiving module can be radio modules or cable-bound modules. The 2-way communication between the helmet light 10 and the input device can be established via a common communication protocol. The use of a common communication protocol also allows to realize a more complex control of the helmet light system, which goes beyond a simple closing of an electrical circuit for switching on and off. The control of the helmet light system can be correspondingly flexible.

The 2-way communication used can be protected by encryption. In this way, unintentional external operation by any input device which connects randomly to the helmet light 10 of the helmet light system can be prevented. This is particularly expedient if several helmet light systems are used in each case with their own input devices close together. In this context, provision may be made for the entry of a password in order to secure the connection. The operating information received by the input device can also comprise status information of the helmet light system. The input device can then output the status information of the helmet light system. This also facilitates the operation of the helmet light system. The helmet light 10 of the helmet light system can also be connected to a further input device, while it is already connected to the input device. It is possible that the helmet light 10 is then controlled primarily by the further input device. In this way, for example, priority operation can be performed by an operational director or a monitoring system installed at a location, for example switching on a camera, a helicopter light or a position light if the helmet light system has such possibilities. Likewise, the switching off of individual operating functions can be prevented by the higher-level instance.

The helmet light system, which already comprises at least one helmet light 10 with a control controller and can be switched by the control controller into several operating modes and states, can be supplemented by a camera unit, which is then operatively connected to the control controller. The control controller can activate the connected camera unit as soon as the helmet light 10 of the helmet light system is activated. It is also possible that the activation already takes place as long as the helmet light system is in a stand-by mode and does not emit any light yet. This allows an automated documentation of what the user of the helmet light system does and sees, in particular, it can be avoided that the user forgets to comply with a possible documentation obligation.

The camera unit can store recorded videos internally. In this way, longer-term archiving can take place. The camera unit can also send recorded videos to the helmet light 10, for example for storage in a memory integrated into the helmet light 10. In this way, too, longer-term archiving can take place. It is preferably provided that the control controller transmits videos recorded by the camera unit as operating information to an external storage device which can be connected to the helmet light system. In this way, a virtually unlimited documentation period can be realized. The external storage device can also be called up by a third party, in particular for the optical representation of the video, in order, for example, to provide assistance to the user of the helmet light system in the event of a problem. For example, to instruct the user on the problem. In particular, for this purpose, the helmet light system can comprise a headset, via which the user can communicate with a third party, which provides the assistance. The communication can take place, for example, via a mobile radio connection, wherein the helmet light system is coupled, for example, to an input device providing the mobile radio connection, for example a mobile telephone. The control controller can be set up to adjust a recording direction of the camera unit as a function of an operating mode and/or an operating state of the helmet light 10. This can improve the quality of the recordings taken by the camera. In particular, a recording direction and a brightness of the produced recording can be set.

The control controller can also be set up to adjust a dynamic focal length of the camera unit as a function of an operating mode and/or an operating state of the helmet light. In this way, too, a recording quality of the camera can be improved. This can be done, for example, by adjusting the zoom, for example, to widen or reduce the viewing angle.

The properties of the helmet light system described above can also be generally implemented and realized within the framework of a method for operating a helmet light system, which can then be executed by the control controller of the helmet light.

FIG. 8e shows the battery pack 100 from the rear, wherein, in contrast to FIG. 8b, in addition to the connector plug 192, the charging plug 190 is also connected to the battery pack 100. The functioning of the plugs will be explained in more detail below.

FIGS. 8f and 8g show three-dimensional detailed views of a battery pack 100. FIG. 8f shows a section of an upper side of the battery pack 100 and FIG. 8g shows a section of a side of the battery pack 100. A pair of detent lugs 212 can be recognized on the upper side. On the side of the battery pack 100 there is a lateral detent lug 210. Expediently, if a lateral detent lug 210 is provided on one side, a further lateral detent lug can be provided on the opposite other side. The detent lugs 212 and the lateral detent lug 210 (as well as a possible further lateral detent lug) can cooperate in particular with a battery holder 214, which will be described in the following, and fix the battery pack 100 in this battery holder 214 to the protective helmet 30. The detent lugs 212 and the lateral detent lug 210 are represented only in FIGS. 8f and 8g, but can also be provided in the battery packs 100 represented in the other figures.

FIGS. 8h, 8i and 8j show the battery pack 100 from different viewing angles without connected plugs. The battery pack 100 represented in FIG. 8h is in a switched-off operating state, so that the display area 2008 displays nothing. However, it is also conceivable that the display area 2008 also shows at least the on/off button 2004 in the currentless state, for example in the form of a transparent foil image. In the lower area of the battery pack 100, electrical contact surfaces 1112c are visible on an end face 1124 of the battery body 194. Further, a notch-like recess 1114a is visible, which serves for centering the connector plug 192 or the charging plug 190 and at the same time prevents a lateral shearing of the plugs from the battery pack 100 in the mounted state. FIG. 8j shows the battery pack 100 from another side, so that the recess 1114a on the end face 1124 of the battery body 194 can be recognized more clearly. FIG. 8i represents the battery pack in such a way that the further end face of the battery pack 100 opposite the end face 1124 is visible, which may be designed, for example, completely smooth. If required, however, further connection possibilities, in the form of electrical contact surfaces, guide elements or additional operating elements can also be arranged on this further end face.

FIGS. 9a, 9b and 9c show three-dimensional representations of a connector plug 192 from different viewing directions. FIGS. 9a and 9c show a connection side of the connector plug 192 provided with an electrical contact 1108a. A projection 1116a is clearly recognizable on this connection side which forms, together with the recess 1114a which can be recognized, for example, in FIG. 8j, a guide element which assists in positioning the connector plug 192 on the battery pack 100. The projection 1116a centers the connector plug 192 together with the notch 1114a of the battery pack 100 on the battery pack 100. In this way, a blind joining of the battery pack 100 with the battery plug 192 can be made possible. FIG. 9b shows a representation of the battery plug 192 from the side opposite the electrical contact 1108a.

The electrical contact 1108a can comprise individual pin contacts. These pin contacts can be designed, for example, to be telescopically compressible, wherein in particular a prestress for the extended state of the pin contacts can be provided. In this way, when the connector plug 192 is brought together with the battery pack 100, electrical contact closure can be reliably guaranteed by a contact pressure which is produced, without there being any risk of bending of the electrical contact 1108a on the respective associated electrical contact surface 1112c, which may be embodied in particular as a smooth or flat surface. The individual pin contacts can have, for example, spring-like elements in order to achieve the prestress. However, alternative designs are also known to the person skilled in the art. This design also permits a lateral disconnection of the plug from the battery pack.

A recess 1114b is again provided on the side opposite the electrical contact 1108a, which is represented in FIG. 9b, i.e. on the rear side of the battery plug 192. Further, an electrical contact surface 1112a can also be recognized, wherein the electrical contact surface 1112a serves for the electrical connection of the connector plug 192 to the charging plug 190.

The entire interior of the connector plug 192 can be cast by means of a casting compound 1110a. The casting compound 1110a then forms the housing of the battery plug 192. Alternatively, it is also possible to produce with housing shells which are then tightly connected to one another in order to achieve a functionality, in particular a fluid tightness, of the housing which is analogous to the casting compound 1110a. The provision of interconnected housing shells can have advantages with regard to exchangeability or control of the individual parts in the interior of the connector plug 192, thus improving the environmental friendliness of the helmet light 10 as a whole.

With the help of the different possible and matching combinations of projections 1114a, 114b and recesses 1116a, 1116b, a simple joining aid for the plug connection can be realized, which does not impede the simple release in the case of a tensile force on the connector plug 192 and at the same time ensures that, in the absence of a tensile force, the electrical contacts closed with the help of the plug connection remain securely and, above all, correctly connected to one another. If the respective projections and recesses are arranged asymmetrically on the contact surfaces, a simple anti-rotation protection is realized.

FIGS. 9d and 9e show a possible internal setup of a connector plug 192 from two substantially opposite viewing directions, so that a front side and a rear side of the inner setup are visible. For the sake of simplicity, cable connections of the connector plug 192 leading away from the connector plug 192 were omitted. A PCB 1106a, on which the already known electrical contact 1108a is arranged, is located inside the connector plug 192, covered by the casting compound 1110a or a housing fulfilling the same function. The electrical contact surface 1112a can be recognized on the opposite side. Both the electrical contact 1108a and the electrical contact surface 1112a reach through the casting compound to the surface of the connector plug 192, so that further elements can be electrically contacted with the connector plug 192 on both elements. Two magnets 1104a are located in the lateral area of the PCB 1106a. The magnets 1104a cooperate with corresponding counterparts in the battery pack 100 or the charging plug 190, so that a polarity reversal of the electrical connections can be ruled out during the connection. This serves as an additional safety measure. Further, the magnets 1104a together with the corresponding counterparts on the battery pack 100 pull the connector plug 192 automatically into the correct position and ensure a secure holding together between the connector plug 192 and the battery pack 100 even under mechanical loading in the joining direction.

By means of this coupling and connecting mechanism, it is possible overall for interlocking cable loops of the connection cable 24 to be able to open if the user of a protective helmet 30 equipped with the helmet light system makes an uncareful movement while wearing the protective helmet 30. As soon as the tension on a hooked cable loop exceeds the holding force which can be applied by the magnets 204, 1104a, 1104b, the connector plug 192 is automatically released from the battery pack 100 while the cable loop opens. Further, the connection of the connector plug 192 to the battery pack 100 is facilitated, since the magnets 204, 1104a, 1104b automatically pull the two components of the plug connection into the correct position, so that the blind closing of the connection is greatly simplified.

FIGS. 10a and 10b show three-dimensional external views of a charging plug 190 from different viewing directions. The charging plug 190 already known from FIGS. 8d and 8e likewise has a projection 1116b, similar to the connector plug 192. Further, an electrical contact 1108b on the same side of the charging plug 190 is also provided. Analogously to the connector plug 192, the housing of the charging plug 190 is likewise formed by a casting compound 1110b, wherein a fluid-tight setup of individual housing elements, in particular housing shells, is also possible here. On the side of the charging plug 190 represented in FIG. 10a, which is opposite the side with the electrical contact 1108b, there is no electrical contact surface, unlike in the case of the connector plug 192. With the help of the possible combinations of the projection 116b and the recess, a simple joining help for the plug connection can be realized, which does not impede the simple release in the case of a tensile force on the connector plug and at the same time ensures that, in the absence of a tensile force, the electrical contacts closed with the help of the plug connection remain securely and, above all, correctly connected to one another.

In this context, it can be provided that the projection and the recess are each asymmetrically formed, preferably at one rim, of the respective connection surfaces. Thereby, a simple anti-rotation protection is realized.

FIGS. 10c and 10d show a possible internal setup of a charging plug 190 from two substantially opposite viewing directions, so that a front side and a rear side of the inner setup are visible. In each case, a PCB 1106b of the charging plug 190 provided in the interior of the charging plug 190 is shown, on which, analogously to the connector plug 192, electrical contact surfaces 1112b and an electrical contact 1108b and magnets 1104b are likewise provided.

The setup of the represented PCB 1106b thus largely resembles the setup of the PCB 1106a already known from FIGS. 9d and 9e. Since the PCB 1106b is associated with the charging plug 190, the PCB 1106b can have a different setup with respect to the represented electrical contact surfaces 1112b and the electrical contact 1108b, which in particular comprises fewer individual electrical contact pins of the electrical contact 1108b. This can be attributed to the fact that the charging plug 190 is usually attached last or is only temporarily connected to the battery pack 100, in particular while the connector plug 194 which must “conduct” the electrical contact 1108b of the charging plug 190 to the battery pack 100 is already fastened to the battery pack 100. It is conceivable in this context, for example, that the PCB 1106b and the PCB 1106a are largely identical in their respective setup, but, depending on the need, in particular, fewer electrical connections are led to the outside to the surface of the charging plug 190. This can reduce the number of different parts if identical PCBs can be used for the charging plug 190 and the connector plug 192 and, for example, only the assembly with electrical components, such as the electrical contacts 1108a and 1108b, varies.

FIGS. 11a and 11b each show a three-dimensional representation of a charging connection of a battery pack 100. In the lower area of the two FIGS. 11a and 11b, the battery body 194 of the battery pack 100 is partially visible. In the upwardly terminating area of the battery body 194, the connector plug 192 is already put on in FIG. 11a. In the representation selected in FIG. 11a, the connector plug 192 comprises a circumferential sealing lip 196 pointing radially inward with respect to an axial longitudinal extension of the battery body 194. The sealing lip 196 is located in the axial direction below a projecting circumferential collar 196a of the connector plug 192. The sealing lip 196 serves in particular to establish a sealing connection, i.e. a fluid-tight connection, between the connector plug 192 and the charging plug 190, which is not represented in FIG. 11a and can be put on the battery body 194 in the axial direction of extension. This is relevant in that the electrical connection points between the connector plug 192 and the charging plug 190 would corrode to an increased extent if moisture were to occur during an existing current flow between the connector plug 192 and the charging plug 190. At this point it should be noted in this regard that the connector plug 192, which was described above in the context with FIGS. 9a to 9c, does not have such a collar 196a and no sealing lip 196, but can be supplemented in a simple manner by these elements. Alternatively, it is of course also conceivable that the collar 196a and the sealing lip 196 are not provided on the connector plug 192 but on the charging plug 190. This would then have the advantage that the electrical contact 1108b of the charging plug 190 projecting out of the plane of the connector plug receives additional protection from mechanical damage by the collar 196a.

FIG. 11a further represents charging contacts 198 and communication contacts 200. The charging contacts 198 and the communication contacts 200 are located on the surface of the connector plug 192 enclosed by the sealing lip 196. Due to the arrangement of the charging contacts 198 and the communication contacts 200, a non-rotatable mounting of the charging plug 190, not represented, can be realized. The special arrangement of the charging contacts 198 and of the communication contacts 200 is to be understood as an example. In particular, the charging contacts 198 and the communication contacts 200 can be further subdivided. It is also conceivable that, in addition to the charging contacts 198 represented in FIG. 11a and the communication contacts 200, further contacts are provided on the surface of the connector plug 192 enclosed by the sealing lip 196. In the event that the electrical contact surface 1112a for the charging plug 190 on the connector plug 192 is embodied to be rotationally secure, for example half of the charging contacts 198 and the communication contacts 200 can be brought together in the interior of the connector plug 192 in order to realize a simple rotation security in this way. The connection surfaces of the battery pack 100 and of the connector plug 192 represented in FIGS. 11a and 11b each have no projection or no recess, as described, for example, from the preceding figures, in order to realize an anti-rotation protection. However, these can be supplemented in a simple manner.

FIG. 11b represents the upper part of the battery body 194 of the battery pack 100 without the connector plug 192, wherein the latter comprises, analogously to the free end of the connector plug 192, a sealing lip 208 arranged behind a collar 208a in an axial extension direction of the battery body 194 and which surrounds an end face of the battery body 194. An electrical contact surface in the form of communication contacts 202 and connecting contacts 206 is again indicated on the end face of the battery body 194. The connecting contacts 206 can be provided both for the electrical supply of a connected helmet light 10 with electrical energy and for charging the battery pack 100. It should further be noted that the respective communication contacts 200, 202 and the connecting contacts 206 or the charging contacts 198 are represented recessed with respect to the respective end face, i.e. are located below the outwardly pointing respective housing surface. This arrangement is optional, it can also be provided that all or at least some contacts terminate flush with the outwardly facing respective housing surface. Further, it is again possible to arrange the sealing lip 208 and the associated collar 208a on the connector plug 192.

Further, magnets 204 are indicated on the end face of the battery body 194, which can hold the connector plug 192 on the battery body 194 in a desired connecting position. The sealing lip 208, like the sealing lip 196 on the connector plug 192, ensures the water-protected electrical contact between the battery body 194 and the connector plug 192 connectable thereto or the charging plug 190, if the latter is connected directly to the battery body 194 for charging the battery pack 100. The magnets 204 are represented in FIG. 11b on the visible surface of the end face of the battery body 194. However, they can also be arranged invisibly, in particular to prevent corrosion of the magnets 204, under the protective outer casing of the battery body 194, i.e. within the housing of the battery body 194. The arrangement of the magnets 204 is optional. However, if the magnets 204 are present, they can, given a suitable selection of the poles pointing away from the battery body 194, not only serve to fix a plug to be connected in a desired position, but also provide an anti-rotation protection, provided that the plug to be connected, the connector plug 192 or the charging plug 190, likewise has magnets with a suitable orientation.

FIGS. 12a and 12b show an internal setup of a battery pack 100 from different viewing directions. In FIGS. 12a and 12b, two battery cells 1118 can in each case be recognized. These battery cells 1118 have a conventional cylindrical shape in an axial direction of extension. A PCB 1106d and a cover 1122 which is electrically insulated or insulating with respect to the PCB 1106d can be recognized on the surfaces which point downwards or rearwards in FIG. 12a and which point forwards or upwards in FIG. 12b. The cover 1122 can consist, for example, of sheet metal and be electrically insulated from the PCB 1106d. Also indicated on the PCB 1106d are electrical contact surfaces already known from FIG. 11b, but in an arrangement different from FIG. 11b.

In addition to the PCB 1106d, a further PCB 1106c is located on the upwardly facing surface of the battery cells 1118, on which a foil cover 1120 is indicated, which can have both a key and a display functionality for the battery pack 100. The key and display functionality of the foil cover 1120 has already been explained previously in the context with FIGS. 8c and 8d. The components represented in FIG. 12b can be cast, for example, into the housing of the battery body 194 or otherwise integrated in order to form the battery pack 100, as indicated in the miniature representation in the upper right-hand corner of FIG. 12b, wherein the battery pack 100 is shown there together with the connector and charging plugs 190, 192, which are not described in detail thereon. The external shape of the battery pack 100 can of course be of variable design and, in particular, does not have to correspond exactly to the miniature representation.

A battery pack temperature sensor can also be arranged inside the battery pack 100 or on its surface. This battery pack temperature sensor can detect a battery pack operating temperature value of the battery pack which is transmitted, for example, to a control controller of the helmet light 10 and received by it. Based on the received battery pack temperature value, the control controller can then change an operating state of the helmet light 10, for example in order to keep the battery pack 100 within a tolerable temperature range. The battery pack 100 further comprises an electrical heating unit, which can be controlled by the control controller, in particular based on the received battery pack temperature value. For example, the control controller can switch on the electrical heating unit if the battery pack 100 falls below a lower temperature threshold value T_{Akku_min}. The switching off of the electric heating unit can, of course, also be temperature-controlled, advantageously in a hysteresis-like manner when another threshold value is exceeded, which is somewhat greater than the lower temperature threshold value T_{Akku_min}. The control controller can further lower a light output of the helmet light if the detected battery pack operating temperature value of the battery pack 100 exceeds a tolerable temperature threshold value T_{Akku_max}. By lowering the light output, i.e. a reduction in the brightness of the helmet light 10, the electrical power taken from the battery pack 100 is reduced, which directly causes a reduction in the waste heat produced, so that the temperature of the battery pack 100 can fall, wherein a constant rate of emission of the waste heat to the environment is assumed. This can be advantageous, for example, in an environment at risk of explosion.

FIGS. 13a to 13h show various three-dimensional representations of a battery holder 214. The battery holder 214, which is at least partially represented in each case, comprises a frame 220 into which the previously described battery pack 100 can be inserted in an axial insertion direction. For this purpose, the frame 220 of the battery holder 214 has a substantially cylindrical outer structure with a rectangular base surface with rounded edges. As can be recognized in FIG. 13a, the frame 220 is narrowed at one end face in the axial direction of extension, so that the battery pack 100 cannot enter into the frame 220 or exit from it at this side. On the opposite end face in the axial direction of extension of the frame 220, the latter is, however, formed in its cross-section substantially not narrowed relative to the rest of the frame 220, so that the battery pack 100 can be inserted from this side into the frame 220 of the battery holder 214. The cylindrical structure of the frame 220 of the battery holder 214 permits the easy insertion of a battery pack 100 with a constant cross-section. The battery pack 100 can be fixed in the frame 220 of the battery holder 214 by means of an elastic tab 224. With the help of the tapering, a stop can thus be realized when inserting a battery pack 100 into the battery holder 214, wherein the tab 224 arranged at the other end simultaneously clamps the inserted battery pack 100 within the frame 220. The frame 220 of the battery holder 214 encloses the space in which the battery pack 100 can be arranged such that substantial areas remain free, so that the battery pack 100 remains visible through the frame 220 of the battery holder 214. In this way, in particular, a sufficient heat dissipation of the battery pack 100 during a charging/discharging process can be ensured, since the frame 220 does not additionally thermally insulate the inserted battery pack 100 from the environment.

The frame 220 of the battery holder 214 is further adjoined by upper holding arms 216a and 216b. The upper holding arms 216a and 216b each open into upper holding hooks 218a, 218b, which ultimately serve to fasten the battery holder 214 to a helmet shell 36. The upper holding hooks 218a and 218b each comprise a step 223, the function of which will be explained in more detail later. Further, lower holding hooks 222a and 222b are also arranged directly on the frame 220 of the battery holder 214. The upper and lower holding hooks 218a, 218b, 222a and 222b serve together for the secure fixing of the battery holder 214 to a helmet shell 36. The exact interaction of the upper and lower holding hooks 218a, 218b, 222a and 222b with the helmet shell 36 will be described in more detail later.

The special design of the battery holder 214 described in FIGS. 13a to 13h serves to guarantee the safety of a user of the protective helmet. Thus, by providing the upper and lower holding hooks 218a, 218b, 222a, 222b, a fixed positioning of the battery holder 214 on the helmet shell 36 is achieved, which is nevertheless easily detachable if this should be necessary. An object impinging from above on the protective helmet 30, for example a branch, can slide down on the protective helmet 30 and, in the process, if it should catch with the battery holder 214, release the battery holder 214 from the protective helmet 30 without the protective helmet 30 being torn from the head of a user wearing the protective helmet 30 and without the user experiencing the full impact force of the impinging object.

The orientation of the open hooking sides of the upper holding hooks 218a, 218b in the direction of the open hooking sides of the lower holding hooks 222a, 222b ensures that, in the case of an object impinging from above on the protective helmet 30 and impinging on the battery holder 214, a release force is generated which first loads the closed side of the upper holding claws 218a, 218b, so that they may break under the impact force and thus initiate a release of the battery holder 214 from the helmet shell 30. At the same time, the lower holding claws 222a, 222b are pushed down in their open direction by the helmet shell 30 and the battery holder 214 is thereby completely released from the helmet shell 30. Since the open hooking sides of the upper holding hooks 218a, 218b are larger than the open hooking sides of the lower holding hooks 222a, 222b, as represented in the figures, the battery holder 214 can be easily fastened to the helmet shell 30, since the bending of the upper holding hooks 218a, 218b during the fastening process requires a comparatively small force. At the same time, the force required for breaking the upper holding hooks 218a, 218b is kept comparatively small by this configuration, so that the release of the battery holder 214 in the event of an emergency, that is to say in the case of an object impinging from above on the protective helmet 30, also takes place simply and easily.

FIG. 14a shows a helmet shell 36 with a helmet light 10 in a frontal view. The viewing direction also shows the lens unit 14 of the helmet light 10, which faces the observer. In the frontal view represented, a part of the fixation of the helmet light 10 to the helmet shell 36 can also be recognized in particular. From the fixing of the helmet light 10 to the helmet shell 36, the already known fastening points, for example from FIG. 2a or 2c, in the form of the front holding claws 112 and 114 are hooked into a notch/groove 58 on a front edge 56 of the helmet shell 36. This is possible because the front edge 56 of the helmet shell 36 has a certain width, so that there is a notchable surface. The two front holding claws 112, 114 of the helmet light 10 are hooked into the notch/groove 58 provided there during mounting, wherein for this purpose an elastic deformation of the front holding claws 112, 114 or of the helmet shell 36 takes place when the helmet light 10 is pressed against the helmet shell 36 when the front holding claws 112, 114 are more elastic than the helmet shell 36. When the helmet light 10 has reached the mounting position, the elastic deformation reverses and the front holding claws 112, 114 snap into the notch/groove 58 at the front edge 56. Alternatively, it is also conceivable that the helmet shell 36 is more elastic in the area of the notch/groove 58 than the front holding claws 112, 114, so that the elastic deformation during the mounting takes place substantially at the notch/groove 58, while the front holding claws 112, 114 remain substantially dimensionally stable.

FIG. 14b shows a detailed view of a helmet shell 36 with a helmet light 10 fastened thereto. In FIG. 14b, a viewing direction which differs from that of 14a is selected, so that the helmet light 10 is shown “from below” and is thus also seen from “below” into the helmet shell 36. The switch 120, the glare shield 124, the holding elements 122 arranged on the right and left sides as well as the cooler element 20 with its cooling ribs and the circumferential bead are visible from the helmet light 10.

The curved shape of the cover element 22 ensures, in particular by means of the holding elements 122 arranged at the right and left ends in each case, that the helmet light 10 clipped into the helmet shell 36 cannot slide laterally, but instead remains firmly fixed in a central position. As already mentioned, the clipping-in takes place, for example, with the help of the front holding claws 112 and 114, which are not visible in FIG. 14b, in cooperation with the rear holding claws 116, 118, which hook the helmet light 10 on a reinforcing rib 62 of the helmet shell 36 on the side of the helmet light opposite the front holding claws 112 and 114.

FIG. 14c shows a section of the helmet shell 36 from above. While FIG. 14d shows a section of a helmet shell with a helmet light fastened thereto from the oblique bottom. In FIG. 14c, in particular the front edge 56 of the helmet shell 36 and a structuring in the form of profile lines which is present on the surface of the helmet shell 36 and which serves to stiffen the helmet shell 36 can be recognized. The profile lines present on the upper side of the helmet shell 36 can interact in particular with the already mentioned reinforcing rib 62 on the inner side of the helmet shell 36 in order to achieve the desired mechanical stability. In FIG. 14d, on the other hand, the helmet light 10 as well as the front edge 56 with the notch/groove 58 and the front holding claws 112 and 114 hooked therein can be recognized more clearly. The notch/groove 58 on the front edge 56 also has a positioning aid for the helmet light 10 in the form of a web 110 which limits the movability of the front holding claws 112 and 114 in the notch/groove 58 on the front edge 56 of the helmet shell 36.

FIG. 14e shows a detailed view of the helmet shell 36 in sections with a helmet light 10 fastened thereto from obliquely below. In particular the glare shield 124, the front holding claw 112, one of the holding elements 122, the switch 120, the cooler element 20 with the associated cooling ribs and the circumferential bead, the plug connection 3000 and the rear holding claws 116, 118 hooked into the reinforcing rib 62 are visible from the helmet light 10. For mounting the helmet light 10 on the helmet shell 36, the helmet light 10 is first inserted with its rear holding claws 116, 118 into the reinforcing rib 62 and then the helmet light 10 is pressed upwardly obliquely in the direction of the front edge 56 of the helmet shell 36, so that the front holding claws 112 and 114 can each engage in the associated portion of the notch/groove 58 on the front edge 56 of the helmet shell 36 after an elastic deformation of the participating fastening points and/or of the helmet shell 36. The curved holding elements 122 also contribute to a reliable centered positioning of the helmet light 10 and can, for example, form a pincer-like structure with the front holding claws 112, 114. As an alternative to hooking the front holding claws 112, 114 into the notch/groove 58, in an embodiment not represented, hooking onto a further inner structure on the inside of the helmet shell 36 is also conceivable, but this structure is at least closer to the rim of the helmet shell 36 than the inner structure in the form of the reinforcing rib 62, into which the rear holding claws 116, 118 hook. The reinforcing rib 62 likewise serves, just like the structuring recognizable on the upper side of the helmet shell 36 in FIG. 14c, for stiffening the helmet shell 36. Extension-like branches 64 arranged by the reinforcing rib 62 on the inside of the helmet shell 36 can also contribute to the positioning of the helmet light 10 during and after its mounting on the helmet shell 36, since they can, for example, limit the possible positions of the rear holding claws 116, 118 when the helmet light 10 is inserted on the reinforcing rib 62.

FIG. 15 shows a three-dimensional overall view of a helmet shell 36 with a helmet light 10 fastened thereto from below. Inside the helmet shell 36 represented in FIG. 15 there is indicated a support cage 42 which will be described in more detail below and which is an integral component of a protective helmet 30 with the helmet shell 36. In the context with the support cage 42, a tensioning unit 48 is to be mentioned, with the help of which the support cage 42 can be adapted in its size to a head size of a user, in particular during putting on and taking off. In FIG. 15, pointing to the right, the helmet light 10 is represented fastened to the helmet shell 36 in the “front” area thereof. Additionally recognizable in this front area is a face protection 32 which is connected to the helmet shell 36 via a bow construction not described in more detail in FIG. 15 and is pivotably mounted thereon. In the left area of FIG. 15, which corresponds to the “rear” area of the helmet shell 36, the battery holder 214 is indicated, which is intended to contain the battery pack 100. The helmet light 10 is coupled via the connection cable 24 to the battery pack 100 present in the battery holder 214. The connection cable 24 can be coupled fixedly or detachably to the helmet light 10, as has already been explained in more detail in the context with FIG. 1. On the opposite side of the helmet light 10, there is also provided the connecting plug connection 3002, likewise already known from FIG. 1, with a further connection cable 28 inserted thereon. The connecting plug connection 3002 with the further connection cable 28 arranged thereon can be used in particular for connecting the “helicopter light” already described in more detail above to the helmet light 10. The battery holder 214 indicated in the rear area of the helmet shell 36 can be fastened in particular to openings present in the helmet shell 36 via the upper holding hooks 218a, 218b only indicated in FIG. 15, wherein the lower holding hooks 222a and 222b of the battery holder 214 are covered by further elements of the protective helmet 30 in the representation selected in FIG. 15.

FIGS. 16a to 16c show further detailed views from below of a section of the helmet shell 36 with the helmet light 10 fastened thereto. Many of the represented components of the helmet light 10 are already known from the preceding figures. In FIG. 16c, in addition to the helmet light 10, a pair of protective goggles 130 can be recognized which is also part of the protective helmet 30, to which the helmet light 10 and the helmet shell 36 also belong. The protective goggles 130 are fixed to the helmet shell 36 in such a way that they can be pivoted relative to the latter. In this way, they can either be pivoted out of the helmet shell 36, so that they substantially serve a user wearing the protective helmet 30 as protection for their eyes, or can be pivoted back under the helmet shell 36. The helmet light 10 lies substantially within the helmet shell 36 between the protective goggles 130 and the helmet shell 36, in particular the helmet light 10 lies in the free space which usually remains between the protective goggles 130 and the helmet shell 36 when the protective goggles 130 are pivoted back into the helmet shell 36.

In addition to the protective goggles 130, FIG. 16b also indicates the support cage 42, which, as seen from the helmet shell 36, is located even further “inwardly” away from the helmet shell 36, so that, from the outside inwardly, first the helmet shell 36, then the helmet light 10, then the protective goggles 130 and finally the support cage 42 are located.

FIGS. 17a and 17b show detailed views of a cutout of a helmet shell 36 with a battery holder 214 fastened thereto from different viewing directions. The battery holder 214 is in each case empty, that is to say in particular that no battery pack 100 is pushed into the battery holder 214. On the helmet shell 36 there are openings which can be aligned with the ventilation openings 53 which are in turn provided on the ventilation slide 50 which was described by way of example in FIGS. 7a to 7c. The ventilation slide 50 is displaceably fixed to the helmet shell 36, so that the openings on the helmet shell 36 can be brought to coincide with the ventilation openings 53 on the ventilation slide 50 (are opened) or are displaced relative to one another, so that the openings on the helmet shell 36 are at least largely closed by the ventilation slide 50. The openings on the helmet shell 36 and the ventilation openings 53 on the ventilation slide 50 can be arranged in particular symmetrically to a plane of symmetry of the helmet shell 36 extending from the rear, i.e. from the battery holder 214, to the front, i.e. to the helmet light 10.

FIG. 17a represents an opened state of the ventilation openings 53 during the mounting of the battery holder 214, while FIG. 17b represents the closed state with the battery holder 214 mounted, in which the openings provided on the helmet shell 36 are largely covered by the ventilation slide 50.

The battery holder 214 is inserted with the upper holding hooks 218a and 218b through the ventilation openings 53 provided on the ventilation slide 50 and the associated openings on the helmet shell 36, so that a step 223 can rest on the rim of the respective ventilation opening 53 and the respective upper holding hooks 218a and 218b can engage in the helmet shell at the rim of the openings facing the rear lower edge of the helmet shell 36. At the same time or subsequently, the lower holding hooks 222a and 222b are pushed over the rear lower rim of the helmet shell 36, so that, due to the existing elasticity of the material of the battery holder 214, which permits a certain elastic deformation, in particular in the area of the upper holding arms 216a and 216b and of the frame 220 of the battery holder 214, the lower holding hooks 222a, 222b clip in. A sequence for mounting the battery holder 214 on the helmet shell 36 deviating from this is also possible.

In the mounting process associated with FIG. 17a, the battery holder 214 can therefore also first be hooked onto the lower rim of the helmet shell 36 with the lower holding hooks 222a and 222b and then pressed forward/upward in such a way that the upper holding hooks 218a and 218b pass through the ventilation openings 53 and the openings on the helmet shell 36. This state is visible in FIG. 17a. The upper holding hook 218a does not yet engage in the lower rim of the opening in the helmet shell 36. When the battery holder 214 is released, this changes because the elastic deformation of the battery holder 214 reverses and the upper holding hooks 218a and 218b engage downwardly at the rim of the openings of the helmet shell 36. By means of the step 223 provided, the displaceability of the ventilation slide 50 is largely maintained, so that the openings provided on the helmet shell 36 can still be covered at least for the most part by the ventilation slide 50 and can thus be closed.

If an object hits the helmet shell 36 from above, the upper holding arms 216a, 216b permit the greater flexibility of the battery holder 214, which was already helpful during the mounting of the battery holder 214 on the helmet shell 36, and further a later breaking of the upper holding hooks 218a, 218b, since a part of the impact force of the object striking the helmet shell 36 and the battery holder 214 is first reduced as an elastic deformation of the battery holder 214, in particular of the upper holding arms 216a, 216b. When the upper holding hooks 218a, 218b are finally broken by an excessive deformation, it is generally guaranteed that the battery holder 214 is completely detached from the helmet shell 36, falls downwardly and does not only remain partially fixed to the helmet shell 36 and is suspended thereon.

The recognizable step 223 rests against an edge of the helmet shell 36 in such a way that the ventilation slide 50, which is displaceably mounted relative to the helmet shell 36, can be displaced beyond the step 223 in the direction of the edge of the opening in the helmet shell 36. This makes it possible for the ventilation slide 50 to close further the ventilation openings 53 in the helmet shell 53, through which the upper holding hooks 218a, 218b engage in the helmet shell 36.

In FIG. 17b, a structuring of the ventilation slide 50 on which the LEDs known from FIGS. 7a to 7c are arranged on both sides of the edge 4004, namely the helicopter LED 4000 and the further helicopter LED 4002a, which have different beam directions on account of the edge 4004, can be recognized. The beam directions of the two helicopter LEDs 4000 and 4002a which can be recognized in FIG. 17b can be embodied substantially perpendicular to one another in such a way that, for example, the helicopter LED 4000 can function as a “rear light” in the case of an upright support, while the further helicopter LED 4002a then beams upwards and is visible from above. If, on the other hand, the wearer of the protective helmet 30 bends down, the helicopter LED 4000 then radiates upwards. Further LEDs, for example with a “lateral” beam direction, can be provided if required.

FIG. 18 shows sections of a detailed view of the helmet shell 36 with the battery holder 214 fastened thereto and the inserted battery pack 100. In the rear area of the helmet shell 36, in particular, the two lower holding hooks 222a and 222b, which encompass a lower rear edge of the helmet shell 36, can be recognized, which are arranged directly on the frame of the battery holder 214. Below the helmet shell 36, an indicated tensioning unit 48 can further be recognized, which will be explained in more detail in the context with the support cage 42 already mentioned. The connection cable 24 projects from the interior of the helmet shell 36 and extends into the battery holder 214 and, via the connector plug 192, which is not individually visible, establishes a connection between the helmet light 10 fixed in the front area of the helmet shell 36 and the battery pack 100 inserted into the battery holder 214, wherein the battery pack 100 is held by the elastic tab 224 in the frame of the battery holder 214.

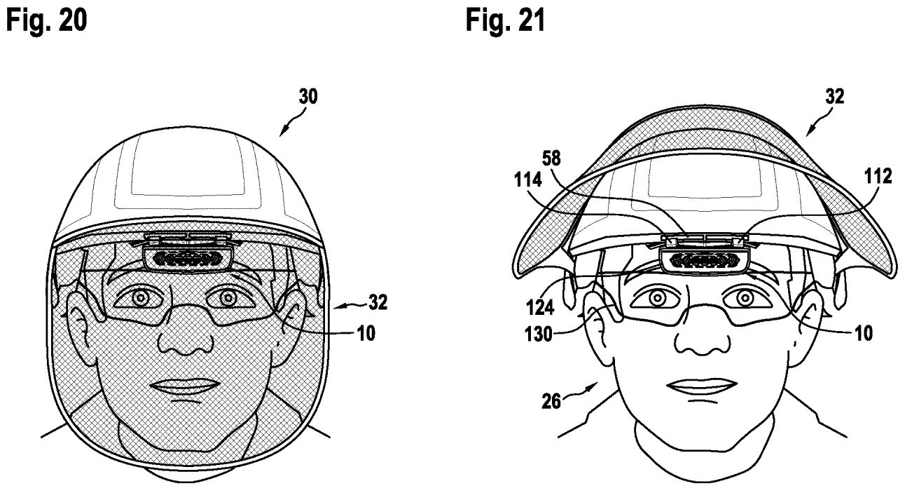

FIG. 19 shows a first frontal view of the protective helmet 30 with the helmet light 10 fastened thereto from the front, while FIG. 20 shows a second frontal view of the protective helmet 30 with the helmet light 10 fastened thereto from the front, and FIG. 21 shows a third frontal view of the protective helmet 30 with the helmet light 10 fastened thereto from the front. FIG. 19 represents the helmet light 10 in its mounted state, so that on the one hand the forward-facing lens unit 14 of the helmet light 10 can be recognized and further the front holding hooks 112 and 114 engaging in the notch/groove 58 can be seen. The protective helmet 30 represented further comprises the face protection 32 which is pivotably fixed with respect to the helmet shell 36 and which can be formed in particular from an open metal grid with a frame reinforcing the metal grid in order to protect the face of a user 26 wearing the protective helmet 30 in the downwardly pivoted state. A different material selection, for example plexiglass or a plastic grid, is also conceivable and can be provided as required. The protective function for the user 26 can be seen in particular from FIG. 20, in which the face protection 32 is pivoted downward relative to the helmet shell 36 of the protective helmet 30 and is located in the viewing direction between the user 26 and the observer. In FIG. 21, the face protection 32, as in FIG. 19, is pivoted upward relative to the helmet shell 36 of the protective helmet 30. At the same time, however, the protective goggles 130, which are also provided, are pivoted downward so that, as already in FIG. 20 with the face protection 32, they lie in the viewing direction between the user 26 of the protective helmet 30 and the observer. The task of the protective goggles 130 is, of course, in particular to protect the eyes of the user 26, be it from dust and dirt.

In the context with the protective goggles 130, provision can further be made for a material selection of the protective goggles 130 adapted to the visual performance of the user 26. This means that the protective goggles 130, which are likewise pivotably mounted relative to the helmet shell 36, can assume the task of a visual aid in the sense of a pair of goggles for the user 26.

FIG. 22 shows a detailed view of a protective helmet 30 with a helmet light 10 fastened thereto from obliquely above. FIG. 22 represents the protective helmet 30 with the face protection 32 pivoted upward relative to the helmet shell 36, wherein also from this perspective, on the one hand, the front edge 56 of the helmet shell 36 remains visible, even if the notch/groove 58 previously recognizable in FIG. 21 is located from the observer below the helmet shell 36, and the face protection 32 is also located from this perspective between the helmet light 10 and the observer. Correspondingly, the helmet light 10, just like the face of the user 26 of the protective helmet 30, is arranged protected by the face protection 32 from mechanical influences from outside.

The protective helmet 30, which is formed in particular for use in forestry, is shown with different fittings in FIGS. 23a and 23b in a side view and in FIG. 24 in an exploded representation and partly in section. Thus, in FIG. 24, in particular, an inner side of the helmet shell 36 is visible. The protective helmet 30 comprises the face protection 32 and a hearing protection 34. Further, the protective helmet 30 comprises the helmet shell 36 and an interior fitting assembly 40, which comprises the support cage 42, a head band 44 and a neck band 46. The neck band 46 is equipped with the tensioning unit 48. The helmet shell 36 is provided on the outside with the ventilation slide 50, by means of which openings 52 formed in the helmet shell 36 can be opened and closed.

Three support arms formed as spacers serve as means for a three-point fastening of the interior fitting or the interior fitting assembly 40 to the helmet shell 36, wherein only two support arms 54 are visible in FIG. 24. For locking the support arm 54 extending in the longitudinal direction of the helmet shell 36 to the helmet shell 36, the latter is provided in the rear head area with a slot in which the correspondingly shaped free end of the support arm 54 pointing in the longitudinal direction can releasably engage on the helmet shell 36. The helmet shell 36 and the support arms 54 are dimensioned and arranged (i.e. dimensioned so long and so wide in their clear width) that a free space is present between the interior fitting assembly 40 and the helmet shell 36 for receiving the helmet light 10, the associated wiring, hearing protection capsules 35a of the hearing protection 34 and other helmet accessories, as well as fastening devices at least for the face protection 32 and the hearing protection 34. The other helmet accessories include the already mentioned tensioning unit 48 of the neck band 46.

In the following, the helmet shell 36, the interior fitting assembly 40, their connection to the helmet shell 36 and then individual parts of the helmet accessories, which comprise the hearing protection 34, the face protection 32 as well as their fastening devices and the tensioning unit 48, are briefly described individually. The helmet shell 36 is formed as a one-piece molded plastic part. A suitable plastic for the helmet shell 36 is ABS, for example.

The helmet shell 36 is advanced forward to such an extent that it simultaneously fulfills the function of a shield above the eyes of the user 26. As a result, the helmet shell 36 has in its front area in the rearward direction a uniformly rising outer surface without any significant gradation, so that it does not offer any hooking points to obstacles such as branches. The transversely extending reinforcing ribs 62 are formed on the inner surface of the helmet shell 36 in the front and in the central helmet area. A further reinforcing rib extending in the longitudinal direction of the protective helmet 30 can be integrally formed transversely to the reinforcing ribs 62 and centrally. In the central area of the helmet shell 36, the reinforcing ribs 62 adjoin an area which is slightly depressed inwards and which has openings 52 in pairs. In the recessed area, the ventilation slide 50 is displaceably arranged on the outer surface of the helmet shell 36 and engages with downwardly and inwardly projecting holding knobs in two front guide slots on the helmet shell 36 and with two further holding knobs in two rear guide slots on the helmet shell 36. The ventilation slide 50 comprises the ventilation openings 53 which are arranged congruently to the openings 52 (FIG. 24) and which, in the ventilation position, are located above the openings 52 and, in the closed position, are arranged offset in such a way that the openings 52 are closed by the ventilation slide 50. The lower rim of the protective helmet 30 is pulled down laterally in the area of the temples and laterally in the area of the back of the head. The above-mentioned free space between the interior fitting assembly 40 and the helmet shell 36 is thereby enlarged downwardly in these areas. This facilitates the attachment of fastening devices to the inside of the helmet shell 36 and the stowing of the hearing protection capsules 35a in the free space between the helmet shell 36 and the support cage 42.

In the aforementioned temple area, three rod-like projections 74b are integrally formed on each side of the inside of the helmet shell 36, on which the interior fitting assembly 40 with the lateral support arms 54 can be fastened in a form-fitting and releasable manner. The rod-like projections 74b can be recognized in the sectional view of the helmet shell 36 of FIG. 24. The rod-like projections 74b are in each case hollow profile parts which are square in cross section and are integrally formed with a foot area on the inside of the helmet shell 36. In their area opposite to the foot area, the rod-like projections 74b are arranged standing freely in front of the inner surface of the helmet shell 36. The connection of the rod-like projections 74b to the inner side of the helmet shell 36 and its transition to the helmet shell 36 in the area adjacent to the connection point in a triangular gusset is reinforced by additional integrally formed ribs between the rod-like projections 74b and the helmet shell 36, so that the rod-like projections 74b are substantially rigidly connected to the helmet shell 36. If a force is exerted on the rod-like projections 74b transversely to their longitudinal direction, which force tends to bend the rod-like projections 74b, then the rod-like projections 74b tend to deform the helmet shell 36 accordingly.

At the rear end, the helmet shell 36 is provided at the lower rim in the center with a recess 76, behind which, when the protective helmet 30 is completely assembled, the tensioning unit 48 of the neck band 46 is located and is thus accessible for manual actuation for tensioning or relaxing the neck band 46.

A fastening device hearing protection 80 for the hearing protection 34 has two hearing protection bearing points 80a on the inside of the helmet shell 36. The hearing protection bearing points 80a are pivot bearings which are integrally formed on the inside of the helmet shell 36 or, preferably, are attached in a non-detachable manner as additional parts. In the hearing protection bearing points 80a, support brackets 37a with the respective hearing protection capsules 35a are pivotably mounted.

A fastening device face protection 84 for the face protection 32 has two face protection bearing points 84a on the inside of the helmet shell 36. Holding arms 132a of a visor 132 are pivotably mounted in the face protection bearing points 84a. The face protection bearing points 84a are not formed on the inner side of the helmet shell 36, but on a plug 136a in each case, which are plugged onto the rod-like projections 74b, in order at the same time to fix the free ends of the support arms 54 on the rod-like projections 74b. The face protection bearing points 84a are located with their assigned plugs 136a in the mounted state in the free space, i.e. in an area in which the helmet shell 36 is pulled downwards at its lower rim, as already explained above.

The interior fitting assembly 40 is that part of the protective helmet 30 which touches the head of the user 26 and consists of the support cage 42, the head band 44 and the neck band 46 which is equipped with the tensioning unit 48. The interior fitting assembly 40 can be fixed to the helmet shell 36 by means of the support arms 54 in order to support and hold the protective helmet 30 on the head of a user 26.

The support cage 42 is formed from a rigid, elastically flexible material, preferably from a plastic such as polyamide. The support cage 42 is provided in two temple areas and in a rear head area with a rigid support arm 54 which projects obliquely downwards or rearwards and which together serve for a three-point fastening of the interior fitting assembly 40 to the helmet shell 36. This arrangement makes possible the free space which extends continuously around the interior fitting assembly 40 in the helmet shell 36 and which in turn serves to receive the hearing protection capsules 35a, the helmet light 10 and other helmet accessories and also fastening devices 80, 84 for the face and the hearing protection 32 and 34. In the exemplary embodiment described here, the support cage 42 is produced as a one-piece molded plastic part. The support cage 42 can be formed from two pairs of mutually spaced support strips which intersect in the center and merge with their lower ends at four connection points into a single, circumferentially closed support strip. An in particular cross-shaped piece of upholstery material can be provided which rests on the support strips in order to increase wearing comfort.

The support arms 54 can protrude from the support cage 42 in particular at the connection points. The head band 44 is integrally formed on the support cage 42. The neck band 46 has two front ends which are releasably connected to rear free ends of the head band 44, for example by a latching connection not represented in more detail. According to the representation in FIGS. 23a and 24, the neck band 46 has two free ends which can be detachably connected to one another in the neck area, specifically with the help of the tensioning unit 48. The neck band 46 can be formed from the same material as the support cage 42. The neck band 46 is connected to the support cage 42 between its connections with the head band 44 and its free ends, in each case in a height-adjustable manner. For this purpose, the support cage 42 has two downwardly projecting support arms, on which the neck band 46 can be fixed in each case at a selectable height. The neck band 46 has three holes arranged one above the other on each side, which can be latched on a resilient bolt 49 projecting on each support arm.

In the example described above, the support arms 54 are fastened to the helmet shell 36 in different ways, but this is not absolutely necessary. The support arms 54 can all be fastened to the helmet shell 36 in the same way. For this purpose, only the different fastening means are to be standardized.

For the three-point fastening of the interior fitting assembly 40 to the helmet shell 36, the rearwardly projecting support arm 54 is inserted into a slot provided for this purpose in the helmet shell 36 until projections provided on this support arm 54 engage on the outside of the helmet shell 36. The interior fitting assembly 40 is then moved further inward in the direction of the inner surface of the helmet shell 36, wherein the laterally extending support arms 54 are passed over the rod-like projections 74b. In this case, through-openings in the laterally extending support arms 54 receive the rod-like projections 74b in a form-fitting manner. When the laterally extending support arms 54 rest in the gusset between the helmet shell 36 and the rod-like projections 74b on the inside of the helmet, plugs 136a are plugged onto the rod-like projections 74b in order to thus fix the laterally extending support arms 54 in their position. The interior fitting assembly 40 and the helmet shell 36 are now firmly connected to one another at three points. As soon as the protective helmet 30 has been placed on the head and fastened to the head with the help of the tensioning unit 48, a chin strap (not represented) can optionally be tightened under the chin. The through-openings in the laterally extending support arms 54 engage the rod-like projections 74b over a length which is at least as large as the clear width of the through-openings. When a force is exerted on the support arms 54 from above by a loading of the helmet 30, the support arms 54 are loaded in tension by the helmet shell 36 which is supported on the ends of the support arms. By means of this force acting on the support arms 54, a moment is generated in each of the three points which tends to deform the helmet shell 36 inwardly up to the lower rim. The helmet shell 36 thus converts part of the force acting on it into deformation energy and thus reduces the force on the person wearing the protective helmet 30. The transmission of the moment from the support arms 54 to the helmet shell 36 is further reinforced by the fact that the support arms 54 are additionally stiffened by integrally formed ribs.

The hearing protection 34 comprises hearing protection capsules 35a, which are each pivotably mounted in a fork-like support bracket 37a. The helmet shell 36 is provided on its inner side with the fixed hearing protection bearing points 80a. In FIG. 24, the hearing protection bearing point 80a is represented together with the support cage 42, but this bearing point is attached on the inside of the helmet shell 36 and not on the support cage 42. The representation in FIG. 24 is intended merely to illustrate where in space the hearing protection bearing point 80a is located with respect to the support cage 42 of the interior fitting assembly 40. In the hearing protection bearing points 80a, the support brackets 37a, which are provided with the hearing protection capsules 35a, are pivotably mounted. The hearing protection bearing points 80a and the support brackets 37a are arranged and formed in such a way that the support brackets 37a can be pivoted in the free space between two positions. In an operating position, the hearing protection capsules 35a cover the ears of the user 26. In a parked position, the hearing protection capsules 35a are stowed in the free space in the helmet shell 36.

Each support bracket 37a is formed so as to be capable of being bent off in a spring-loaded manner in an area between its two ends in which it extends in the free space, so that the hearing protection capsules 35a are in each case folded away from the ear in the non-bent position of each support bracket 37a and are in each case folded against the ear in the bent position of the support bracket 37a. If the protective helmet 30 is not placed on the head, the two hearing protection capsules 35a in the latter part each reach a position which is substantially further inward than the ear against which each hearing protection capsule 35a is to be placed. In other words, the mutual spacing of the hearing protection capsules is in this case substantially smaller than the mutual spacing of the ears. This ensures that, when the protective helmet 30 is put on, the hearing protection capsules 35a are kept pressed against the ears by the spring preload. The spring preloading for bending each support bracket 37a between two defined positions is effected by an annularly bent bow spring 92a. Each support bracket 37a can be moved manually into a bent position and into a non-bent position. In each of these positions, the bow spring 92a effects an end position lock. The end position lock of the support brackets 37a is not achieved when the protective helmet is put on because, as stated, each hearing protection capsule 35a is to be held resiliently pressed against the ear.

In addition, each hearing protection bearing point 80a and each support bracket 37a are formed in such a way that the support brackets 37a can only be pivoted between the operating and the parking position. This ensures that the hearing protection capsules 35a can be stowed in the free space behind the ear without colliding with the ears and the lower rim of the helmet shell 36.

The face protection 32 will be described in more detail below. FIG. 24 shows the protective helmet 30 in an exploded representation and partly in section, wherein the face protection 32 is recognizable in association with other helmet accessories.

The face protection 32 comprises the visor 132 with two holding arms 32a as well as two plugs 136a, on which the face protection bearing point 84a is respectively integrally formed as the fastening device face protection 84. The plugs 136a are plugged onto the rod-like projections 74b, as a result of which the face protection bearing points 84a come to rest in the temple area on the inside of the helmet shell 36. The plug 136a with the face protection bearing point 84a can be recognized in FIG. 24. The oppositely arranged parts of the fastening are not shown. Each face protection bearing point 84a has three axially projecting, elastically flexible cams 85a, over which the holding arms 132a can be pushed with annular bearing bushes in order to detachably and pivotably fasten the holding arms 132a in the face protection bearing points 84a. The face protection bearing points 84a and the holding arms 132a are arranged and formed in such a way that each holding arm 132a can be pivoted in the free space between two positions, an operating position in which the visor 132 is folded down and protects the face (FIG. 20), and a parking position in which the visor 132 is folded up and is arranged in close contact on the outer surface of the helmet shell 36 (FIGS. 21 and 22). The fastening device 84 for the face protection 32 contains a self-locking holder for each holding arm 132a. For this purpose, each plug 136a contains a spring-biased bolt which holds the annular bearing bush 134a attached to the holding arms 132 a in the operating position and in the parking position under spring prestress.

The visor 132 forms with each holding arm 132a a fork (FIG. 24) in which the wall of the helmet shell 36 is closely received when the visor is open. When the visor 132 is closed, its upper rim rests on the front rim of the helmet shell 36, and the lateral rims of the visor 132 rest on the outer surface of the helmet shell 36. Therefore, neither when the visor is closed nor opened is there the possibility that branches can hook onto the holding arms 132a or onto the visor 132 itself and endanger the user 26 when the protective helmet 30 is used, for example during forestry work.

The tensioning unit 48 is briefly described below. In addition to the hearing protection 34 and the helmet light 10, the tensioning unit 48 is a further helmet accessory which, like the hearing protection 34, is always within the contour of the helmet shell 36, so that no projecting parts are present in the area of the tensioning unit 48, on which obstacles could get caught. The two ends of the neck band 46 are releasably connected in the neck area by the tensioning unit 48. The tensioning unit 48 comprises a holder 168 into which the free ends of the neck band 46 are inserted on both sides. The holder 168 has angular knobs which can be brought into engagement with angular openings of the neck band 46. In this way, the length of the neck band 46 can be roughly adjusted in accordance with the head size. The adjustment is expediently effected in such a way that the protective helmet 30 can be conveniently put on when the tensioning unit 48 is not actuated. The neck band 46 is then tensioned with the help of the tensioning unit 48 after the protective helmet 30 has been put on. The tensioning unit 48 is actuated by means of a latch flap 174. By actuating the latch flap 174, a support shell 172 provided with a piece of upholstery material 180 is guided to or away from the rear head of the user 26.

The helmet light 10 fixed to the helmet shell 36 in the front area thereof can also be recognized underneath the helmet shell 36. Further, the battery holder 214 arranged on the outside of the helmet shell 36 in the rear area can also be recognized, wherein only the upper holding hook 218a and the lower holding hook 222a are visible from the holding elements of the battery holder 214. Further, the connection cable 24 is indicated below the helmet shell, which extends from the helmet light 10 to the battery pack 100 arranged in the battery holder 214, which is not visible either. For the sake of simplicity, the connection cable 24 is not guided along the lower rim of the helmet on the inside of the lower edge of the helmet shell 36, but rather transversely through the helmet shell 36 in the available free space and through an opening in the helmet shell 36 directly to the battery pack 100. This may be intended insofar as a connection cable 24 running close to the lower rim of the helmet shell 36 could easily interact with objects outside the helmet shell 36 and, in particular, could be pulled out of the intended position on the battery pack 100 by these without this being intended. In order to avoid this, on the one hand an adapted length of the connection cable 24 is advantageous and further a special recess/opening can also be provided in the helmet shell 36, through which the connection cable 24 can be guided in order to connect the helmet light 10 to the battery pack 100 in the battery holder 214.

FIGS. 25a to 25i each show parts of a graphical user interface for operating a helmet light. The individual views/representations of the parts of the graphical user interface can be displayed, for example, on a separate display which can be coupled to the helmet light 10 in a wireless or wired manner. Various views of the graphical user interface are represented by way of example, in particular in English and in black and white, however, the observer is of course aware that different colors and/or languages can be selected here.

The display, which displays the parts of the graphical user interface in each case, can be part of a smartphone, for example. The smartphone can then be coupled with the helmet light in a cable-connected manner. For this purpose, for example, one of the plug connections 3000, 3002 arranged on the helmet light 10 can be used. The smartphone connected to the helmet light 10 in a cable-connected manner can of course also be used as a power source for operating the helmet light 10 and in particular can also supplement or replace the battery pack 100. It is also conceivable that the smartphone is used to charge the battery pack 100 like a power bank. The smartphone can also be wirelessly coupled with the helmet light 10, wherein the helmet light 10 for this purpose can comprise a short-range communication interface, for example a Bluetooth interface.

Various functions of the helmet light 10 can be controlled via the smartphone, in particular the graphical user interface represented on the smartphone. Further, as represented in FIG. 25a, status information of the helmet light 10 can be represented. For example, the temperature of the helmet light 10, in particular the temperature of the controller board 18 or of a temperature-sensitive element arranged on the controller board 18, can be displayed. Of course, a corresponding temperature of the controller board 18 or of another part of the helmet light 10 can also be detected by a temperature sensor arranged elsewhere on the helmet light 10 or in the helmet light 10. In this respect, an automatically temperature-controlled shutdown or power reduction of the helmet light 10 is possible in order to prevent its damage. Further, a temperature of the battery pack 100 can also be detected and represented. Likewise, the voltage provided by the battery pack 100 and the current strength provided by the battery pack 100 as well as a possible charging current can be detected and represented by sensor elements to be provided accordingly. In addition, the charging state of the one or more battery packs 100, which are electrically coupled with the helmet light 10, can also be displayed. The status overview can also contain information about which of the possible elements of the helmet light 10 and the further elements connected thereto are currently active and with which (adjustable) brightness. By way of example, FIG. 25a represents a walk light (“walk light”), a helicopter light (“helicopter light”) and a battery light (“battery light”) as 100%, which corresponds to a maximum possible light emission of the respective lighting elements or lighting modes. On the other hand, a face light (“face”) is displayed as deactivated, while a work light (“work light”) is represented as partially activated, i.e. with 80% of the maximum possible light emission. The respective status information can be presented both in alphanumeric representation or with the help of different color scales or color intensities or as bar charts. It is also conceivable, for example, that, in order to improve the readability, different status information of the helmet light 10 is displayed alternately, so that less information is reproduced on the same surface, but is represented larger for this purpose in each case.

The helmet light 10 can be operated, for example, with the help of a touch-sensitive display, wherein it is possible, for example, for additional information or functions to be activated or called up by touching one of the different elements represented in the figures. FIGS. 25b and 25c represent some basic information about a helmet light 10 visually within an app that can be installed on a smartphone. The app can serve in particular for connecting the smartphone to the helmet light 10 via a wireless connection, in particular Bluetooth. For this purpose, the helmet light 10 can first be activated via the switch 120. This activation places the helmet light 10 at least in a standby mode in which, for example, a connection establishment with the smartphone can be possible.

An initial screen of a user interface of the app in a (still) uncoupled state is represented in FIG. 25c, while FIG. 25b represents the same initial screen in a (successfully) coupled state.

On the one hand, in the upper area, the status of the connection to the helmet light 10 is characterized by the hatching that a connection is established, and this is at the same time indicated in written form as “Connecting”. The hatching represented in FIG. 25b can in particular indicate a striking color design of the initial screen in the marked area. When the connection is established, the display can be changed accordingly. In addition, in the lower area of FIG. 25b, a camera module of the helmet light 10, which is designated as “PROTOS CAM”, is identified as being switched on and can be controlled via the corresponding button. Identification is again indicated with the help of the hatching, which can again represent a color coding or a color change, and can additionally or alternatively again take place in written form. For example, the various buttons can change from red to green, which could correspond to an inactive or active state. It is also possible to identify a change between a separate and a connected state by changing color. In the lower area of FIGS. 25b and 25c it is further indicated that the full functional scope of the various illumination modes which can be provided by the helmet light 10 can be made recognizable to the user with the help of one or more demo functions. These different demos can on the one hand illustrate the various basic functions of the helmet light 10 to the user in an initial phase and on the other hand serve to check the unrestricted functionality of the illumination modes to be provided, in particular in a later phase of use in which the user has already gained sufficient experience in operating the helmet light 10. In a similar manner, the further FIGS. 25d to 25i also show different operating states of the helmet light 10 visually and/or in written form in the different views of the respectively represented graphical user interface of the app.

In particular, the hatched light cones recognizable in FIGS. 25d, 25f and 25h in the context with the user indicated in stylized form visualize different possible illumination modes of the helmet light 10. Thus, FIG. 25d shows two light cones, wherein the lower one belongs to the walk light and the upper one to the work light. FIG. 25f shows a light cone for a face light in the upper area of the head of the user represented in stylized form and the light cone of the walk light individually in the lower area. FIG. 25h in turn shows light cones of a helicopter light. Different light intensities between 0 and 100% can be selected independently or jointly for the individual illumination modes. Further, a short-term “turbo operation” can also be provided, which lies outside the usual working specification of the LED elements 1610 of the helmet light 10 used and which can increase the light yield of the LED elements 1610 operated in this way for a short time. This functionality can be selected, for example, by permanently holding a “turbo” touch surface represented in the various figures. Further, the temperature display for the helmet light 10 can also be visible, wherein a permissible maximum temperature can be set, for example, via an assigned operating element. Above such a measured maximum temperature, a reduction in the power of the helmet light 10 can be provided. As can be recognized in the lower area of FIG. 25d, different light modes of the helmet light 10 can be switched in different ways, for example pulsating with varying pulse duration. It may also be possible to increase the illumination intensity in time in order to avoid a possible glare effect when the helmet light 10 is abruptly switched on. In a similar manner, with a foreseeable exhaustion of the battery pack 100, a time-extended switching off of the helmet light 10 is also conceivable.

The features of the invention disclosed in the above description, in the drawings and in the claims can be essential for the realization of the invention both individually and in any combination.

### LIST OF REFERENCE NUMERALS

10 helmet light
12 cover
14 lens unit
16 carrier element
18 controller board
20 cooler element
21 cooling rib
22 cover element
23 screw
24 connection cable
25 recess
26 user
28 further connection cable
30 protective helmet
32 face protection
34 hearing protection
35a hearing protection capsule
36 helmet shell
37a support bracket
40 interior fitting assembly
42 support cage
44 head band
46 neck band
48 tensioning unit
49 bolt
50 ventilation slide
52 openings
53 ventilation opening
54 support arm
56 front edge
58 notch/groove
62 reinforcing rib
64 branch
74 bar-like projection
76 recess
80 fastening device-hearing protection
80a hearing protection bearing point
84 fastening device-face protection
84a face protection bearing point
85a cam
92a bow spring
100 battery pack
102 display and operating element
110 web
112 front holding claw
114 front holding claw
116 rear holding claw
118 rear holding claw
120 switch
122 holding element
124 glare shield
130 protective goggles
132 visor
132a holding arm
136a plug
168 holder
172 support shell
174 latch flap
180 upholstery material piece
190 charging plug
192 connector plug
194 battery body
196 sealing lip
196a collar
198 charging contact
200 communication contact
202 communication contact
204 magnet
206 charging contact
208 sealing lip
208a collar
210 lateral detent lug
212 detent lug
214 battery holder
216a upper holding arm
216b upper holding arm
218a upper holding hook
218b upper holding hook
220 frame
222a lower holding hook
222b lower holding hook
223 step
224 tab
1104a magnet
1104b magnet
1106a PCB
1106b PCB
1106c PCB
1106d PCB
1108a electrical contact
1108b electrical contact
1110a casting compound
1110b casting compound
1112a electrical contact surface
1112b electrical contact surface
1112c electrical contact surface
1114a recess
1114b recess
1116a projection
1116b projection
1118 battery cell
1120 foil cover
1122 cover
1124 end face
1400a Fresnel lens
1400b Fresnel lens
1400c Fresnel lens
1402 directional unit
1602 milling
1604 bore
1608 conductor tracks
1610 LED element
1612 mechanical switching element
1614 further mechanical switching element
1616 framing
1804 bending point
1806 bore
2000 temperature display
2002 battery charging level display
2004 on/off button
2006 LED backlight
2008 display area
3000 plug connection
3002 connecting plug connection
3002a connecting connection
4000 helicopter LED
4002a further helicopter LED
4002b further helicopter LED
4004 edge

1-10. (canceled)

11. A helmet light system for fastening to a protective helmet, the helmet light system comprises:
a helmet light which has a plug connection;
a battery holder with a battery pack which has an electrical connection;
a connection cable with a plug and a connector plug, wherein the plug can be connected to the plug connection and the connector plug can be connected to the electrical connection,
wherein the connector plug has magnets which interact with the battery pack and which exert a force on the connector plug which pulls the connector plug into its connection position in which respective connection surfaces of the connector plug and the battery pack come to rest on one another, or keeps it there.

12. The helmet light system according to claim 11, wherein the connector plug has a projection and the battery pack has a recess corresponding to the projection, wherein the projection lies in the recess when the connector plug is correctly connected to the battery pack.

13. The helmet light system according to claim 12, wherein the projection and the recess are each formed asymmetrically, preferably on a rim of the respective connection surfaces.

14. The helmet light system according to claim 11, wherein an electrical contact surface is formed on the connection surface of the battery pack and an electrical contact is formed on the connection surface of the connector plug.

15. The helmet light system according to claim 12, wherein one of the connection surface has a collar surrounding this connection surface with a sealing lip facing the connection surface.

16. The helmet light system according to claim 11, wherein the battery pack has magnets which interact with the magnets of the connector plug and, in doing so, exert a force which pulls the connector plug into its connection position or keeps it there.

17. The helmet light system according to claim 11, wherein the helmet light system further comprises a charging plug, wherein the connector plug, on its back side opposite the connection surface, has a further connection surface with an electrical contact surface for connecting the charging plug.

18. The helmet light system according to claim 17, wherein the charging plug has a projection and the connector plug has a corresponding recess on the further connection surface, wherein the projection lies in the recess when the charging plug is correctly connected to the connector plug.

19. The helmet light system according to claim 17, wherein the charging plug can be directly connected to the battery pack for charging the battery pack.

20. A protective helmet comprises a helmet light system according to claim 11.
